(19) United States
(12) Patent Application Publication
(10) Pub. No.: US 2005/0256851 A1
(43) Pub. Date: Nov. 17, 2005

(54) Information search device, computer program for searching information and information search method

(76) Inventors: Yayoi Nakamura, Yokohama (JP); Hiroshi Sugitani, Yokohama (JP); Shingo Suzumori, Yokohama (JP); Koji Yamamoto, Yokohama (JP); Toshihiro Ide, Yokohama (JP); Daisuke Nagai, Yokohama (JP)

Correspondence Address: KATTEN MUCHIN ROSENMAN LLP, 575 MADISON AVENUE, NEW YORK, NY, 10022-2585, US

(21) Appl. No.: 10/954,045

(22) Filed: Sep. 29, 2004

(30) Foreign Application Priority Data
May 12, 2004 (JP) 2004-142816

(51) Int. Cl. G06F 7/00

(52) U.S. Cl. 707/3

(57) ABSTRACT

To provide an information search device, a computer program for searching information and an information search method for simply providing a broad range of information with brevity to a user. A search condition extraction unit extracts search conditions of a user from inputted information, a search condition loosing unit looses the search conditions of the user and thus creates loosed search conditions, a search control unit performs a search based on the loosed search conditions and outputs search results, a search evaluation unit adds divergence degrees to the search results by use of the search conditions of the user and evaluation data for evaluating the search results, and thus outputs the search results, and a variation result output unit classifies the search results added with the divergence degrees by use of classification criterion data for classifying the search results on the basis of the divergence degrees, selects the search result from among the classified search results and thus outputs the search result. Then the present invention performs a search based on not only a condition which user talks explicitly but also a condition which takes an analogized implicit request into consideration.

### BACKGROUND OF THE INVENTION

The invention relates to an information search device, a computer program for searching information and an information search method by which a user simply readily acquires a desired piece of information from a tremendous quantity of information.

In the field of information search services, there exist a voice response service as typified by Voice Portal and an information providing service on a cell phone as typified by i-mode (registered trademark). At the present, there is such a service that a user performs a voice input of a desired condition with “voices” utilized as an interface. This service serves to search for information matching with the condition. Then, in this service, search results are presented. This type of service shows an increasing tendency.

The service with the “voices” utilized as the interface is applied to general customer oriented services such as a flight information service of ANA (registered trademark), a ticket service of PIA (registered trademark) and so on. Then, these voice-interface services are underway to spread rapidly on the market. Then, the voice-interface services gain a big prospective growth from now into the future. A market prediction about Voice Portal in the year of 2005 estimates 12 billion and 320 million dollars (Radicarri Group INC).

The information search service is a service utilized when wanting to find out a desired piece of information from the tremendous quantity of information. The users of this type of information search service desire for obtaining the necessary pieces of information in a shorter period of time.

Generally, the user inputs search conditions required for searching out the want-to-obtain information of the user himself or herself to the information search service. Then, the user requests the information search service for the search. The information search service presents to the user-pieces of information (search results) that meet the search conditions inputted from the user.

In the information search service based on the method described above, however, a case often arises, wherein even a single record of information can not be retrieved when performing the search under the search conditions inputted by the user. Further, in the information search service based on the method described above, there is also a case of acquiring a tremendous quantity of search results. Therefore, the user is required to retry the search in a way that changes the search conditions in order to reach the target information.

Such being the case, a method of searching by use of loosed search conditions into which the search conditions inputted by the user are loosed, exits as a method of reducing the labor of the user who changes the search conditions once again. This method involves sorting out pieces of information that have met the loosed search conditions in the sequence of proximity to the search conditions inputted by the user from the highest. Then, in this method, the search results are presented in the sequence of the proximity from the highest.

For example, when the user searches for a Real Estate Property, it is assumed that conditions desired by the user are given such as [house layout: 2LDK, rent: 120,000 Yen]. In this case, the system looses the conditions set by the user down to [house layout: 2K to 3LDK, rent: 100,000 to 140,000 Yen]. Then, the system executes the search based on these loosed conditions. Subsequently, the system sorts out the retrieved Real Estate Property in the sequence of the proximity to the desired-by-the-user conditions [house layout: 2LDK, rent: 120,000 Yen] from the highest. Then, the system presents the search results in the sequence of the proximity to the desired-by-the-user conditions [house layout: 2LDK, rent: 120,000 Yen] from the highest.

Further, there is a method of using synonyms as the method of loosing the conditions. Moreover, the method of loosing the conditions may include a method of deleting a low-order condition [MOMOCHIHAMA] into [Sawara-ku, Fukuoka-shi] in the case of hierarchical conditions like [MOMOCHIHAMA, Sawara-ku, Fukuoka-shi], and so forth.

Herein, FIGS. 39 and 40 show diagrams of a principle of the prior art. Operations of respective units shown in FIGS. 39 and 40 are substantially the same as the operations of the corresponding units in diagrams in FIGS. 1 and 2, showing a principle of a first embodiment of an information search device of the invention which will be described later on.

An input/output control unit 1010 controls an interface between a user and a system. Then, the input/output unit 1010 transfers voice data inputted by the user to a voice recognition unit 1020. Moreover, the input/output control unit 1010 receives a search result from a search result generation unit 1110. Further, the input/output unit 1010 provides the user with the search result.

A voice recognition unit 1020 receives the voice data from the input/output unit 1010. Then, the voice recognition unit 1020 recognizes a voice. Then, the voice recognition unit 1020 transfers a recognition result to a search condition extraction unit 1030. The search condition extraction unit 1030 receives the recognition result from the voice recognition unit 1020. Subsequently, the search condition extraction unit 1030 extracts search conditions of the user by use of search condition data 1510.

A search condition loosing unit 1040 generates, from the search conditions of the user, loosed search conditions by loosing the search conditions of the user on the basis of loosing condition data 1520. A search control unit 1050 extracts search result information coincident with the conditions from search target data 1530 on the basis of the search conditions including the loosed search conditions received from the search condition loosing unit 1040.

A search evaluation unit 1060 adds points to the search results based on the loosing conditions by use of evaluation data 1540. Then, the search evaluation unit 1060 sorts out the search results in the sequence of the points. Thus, the search evaluation unit 1060 creates evaluated search results. A search result generation unit 1110 transfers the search results to the input/output control unit 1010.

Search condition data 1510 are data for creating the search conditions of the user from the recognition results outputted by the voice recognition unit 1020. The search condition data 1510 are used by the search condition extraction unit 1030. Loosed condition data 1520 are data for creating the loosed search conditions from the search conditions of the user. The loosed condition data 1520 are employed by the search condition loosing unit 1040.

Search target data 1530 are data serving as a search target and used by the search control unit 1050. Evaluation data 1540 are data employed for evaluating the search results in the search evaluation unit 1060.

[Patent document 1] Japanese Patent Application Laid-Open Publication No. 2001-209661

[Patent document 2] Japanese Patent Application Laid-Open Publication No. 2002-366567

[Patent document 3] Japanese Patent Application Laid-Open Publication No. 7-225772

[Patent document 4] Japanese Patent Application Laid-Open Publication No. 8-234987

In the prior art, the search is conducted by loosing the search conditions inputted from the user. Therefore, in the prior art, a large quantity of search results are presented as the search results. Consequently, the prior art caused the following problems.

[Problem Arising from Presenting Mass of Search Results]

If a mass of search results are presented, the user gets hard to search out a desired piece of information from the mass of search results. Further, in the voice information search service utilized in Voice Portal, it follows that the user continues to listen to the mass of search results on the phone. It is a painful act that the user continues to listen to the mass of search results on the phone because of much futile information contained in those search results. Hence, the service presenting the mass of search results becomes a service that the user does not want to utilize.

Further, in an Internet information search service involving the use of information mobile terminals as typified by PDA (Personal Digital Assistant) and i-mode (registered trademark), a data size of information that can be provided to the user at one time is small. Therefore, in the Internet information search service using these information mobile terminals, it is required that the user goes on reading while scrolling screens at all times. Further, in the Internet information search service using these information mobile terminals, in the case of, for example, browsing next ten records, the communication is performed once again. Therefore, the Internet information search service using these information mobile terminals requires much time. Thus, the Internet information search service using these information mobile terminals is a service painful enough to cause the user to browse the mass of information. Moreover, the Internet information search service using these information mobile terminals is a service that is time-consuming.

[Problem Arising from Searching Based on Conditions Inputted by User]

When searching based on the conditions inputted by the user, it is possible to present the information coincident with the search conditions and with loosed conditions thereof. The method of searching based on the conditions inputted by the user, however, is incapable of offering products and the services, from a different point of view, for and about which the user has a implicit desire, feels attractive and wants to acquire at comparatively a high price.

The user might get disappointed about the conventional information search service due to those factors. Further, the service provider might resultantly lose a business chance. Therefore, the prior art is unsatisfactory also to the service provider.

### SUMMARY OF THE INVENTION

The invention was devised in view of the circumstances described above and aims at providing an information search device, a computer program for searching information and an information search method for simply providing a broad range of information with brevity to a user.

An information search device according to the invention comprises a search condition extraction unit extracting search conditions of a user from inputted information, a search condition loosing unit loosing the search conditions of the user and thus creating loosed search conditions, a search control unit performing a search based on the loosed search conditions and outputting search results, a search evaluation unit adding divergence degrees to the search results by use of the search conditions of the user and evaluation data for evaluating the search results, and thus outputting the search results and a variation result output unit classifying the search results added with the divergence degrees by use of classification criterion data for classifying the search results on the basis of the divergence degrees, selecting the search result from among the classified search results and thus outputting the search result.

An information search device according to the invention, wherein the search condition contains at least one or more tuples of attributes possessed by a search target and information indicating the attributes, the loosed search condition contains at least one or more tuples of the attributes and information into which the information indicating the attributes is changed, the evaluation data contain information for determining the divergence degrees based on the information indicating attributes of the search results searched based on the loosed search conditions and information indicating attributes contained in the search conditions of the user, and said search evaluation unit adds the divergence degrees to the search results based on the information for determining the divergence degrees, and thus outputs the search results.

An information search device according to the invention comprises a search condition extraction unit extracting search conditions of a user from inputted information, an user type analogizing unit determining a type of the user from the search conditions of the user by use of user type determination data for determining the type of the user from inputted information, and outputting a user type result, a implicit request condition generation unit creating the search conditions containing a implicit request from the user type result by use of implicit request condition determination data for determining conditions implicitly requested by the user and a search control unit performing a search based on the search conditions containing the implicit request, and outputting a search results.

An information search device according to the invention, wherein the search condition contains at least one or more tuples of attributes possessed by a search target and information indicating the attributes, the user type is set in the user type determination data in a way that associates the user type with the information indicating the attributes, said user type analogizing unit outputs the user type in the user type determination data, associated with the information indicating the attribute contained in the search conditions of the user, and the implicit request condition is set in the implicit request condition determination data in a way that associates the implicit request condition with the user type result.

An information search device according to the invention, further comprises an another-point-of-view information extraction unit extracting the search results of which a result count is indicated by extraction count data indicating an extraction count from the search results outputted from said search control unit.

An information search device according to the invention comprises search condition extraction unit extracting search conditions of a user from inputted information, a search condition loosing unit loosing the search conditions of the user and thus creating loosed search conditions, a search control unit performing a search based on the loosed search conditions and outputting first search results, a search evaluation unit adding divergence degrees to the first search results by use of the search conditions of the user and evaluation data for evaluating the search results, and thus outputting the first search results, a variation result output unit classifying the first search results added with the divergence degrees by use of classification criterion data for classifying the search results on the basis of the divergence degrees, selecting second search results from among the classified first search results and thus outputting the second search results, an user type analogizing unit determining a type of the user from the search conditions of the user by use of user type determination data for determining the type of the user, and outputting a user type result and a implicit request condition generation unit creating the search conditions containing a implicit request from the user type result by use of implicit request condition determination data for determining conditions implicitly requested by the user, wherein said search control unit searches the first search results on the basis of the search conditions containing the implicit request, and outputs the search results containing the implicit request, and said information search device comprises an another-point-of-view information extraction unit extracting information, which is not contained in the second search results, from the search results containing the implicit request.

An information search device according to the invention, wherein the search condition contains at least one or more tuples of attributes possessed by a search target and information indicating the attributes, the loosed search condition contains at least one or more tuples of the attributes and information into which the information indicating the attributes is changed, information for determining the divergence degrees based on the information indicating attributes of the first search results and information indicating attributes contained in the search conditions of the user, is set in the evaluation data, said search evaluation unit adds the divergence degrees to the first search results based on the information for determining the divergence degrees, and thus outputs the first search results, the user type is set in the user type determination data in a way that associates the user type with the information indicating the attributes, said user type analogizing unit outputs the user type in the user type determination data, associated with the information indicating the attribute contained in the search conditions of the user, and the implicit request condition is set in the implicit request condition determination data in a way that associates the implicit request condition with the user type result.

An information search device according to the invention, wherein said another-point-of-view information extraction unit extracts the search results of which a result count is indicated by extraction count data indicating an extraction count from the search results containing the implicit request that are outputted from said search control unit.

A computer program for searching information according to the invention comprises steps of, extracting search conditions of a user from inputted information, loosing the search conditions of the user, creating loosed search conditions, performing a search based on the loosed search conditions, outputting search results, adding divergence degrees to the search results by use of the search conditions of the user and evaluation data for evaluating the search results, outputting the search results added with the divergence degrees, classifying the search results added with the divergence degrees by use of classification criterion data for classifying the search results on the basis of the divergence degrees, selecting the search result from among the classified search results and outputting the selected search result.

A computer program according to the invention, wherein the search condition contains at least one or more tuples of attributes possessed by a search target and information indicating the attributes, the loosed search condition contains at least one or more tuples of the attributes and information into which the information indicating the attributes is changed, the evaluation data contain information for determining the divergence degrees based on the information indicating attributes of the search results searched based on the loosed search conditions and information indicating attributes contained in the search conditions of the user, and the computer program comprises a step of adding the divergence degrees to the search results based on the information for determining the divergence degrees, and thus outputting the search results.

A computer program for searching information according to the invention comprises steps of, extracting search conditions of a user from inputted information, determining a type of the user from the search conditions of the user by use of user type determination data for determining the type of the user from inputted information, outputting a user type result, creating the search conditions containing a implicit request from the user type result by use of implicit request condition determination data for determining conditions implicitly requested by the user, performing a search based on the search conditions containing the implicit request and outputting a search results.

A computer program according to the invention, wherein the search condition contains at least one or more tuples of attributes possessed by a search target and information indicating the attributes, the user type is set in the user type determination data in a way that associates the user type with the information indicating the attributes, the computer program comprises a step of outputting the user type in the user type determination data, associated with the information indicating the attribute contained in the search conditions of the user, and the implicit request condition is set in the implicit request condition determination data in a way that associates the implicit request condition with the user type result.

A computer program according to the invention, further comprises a step of extracting the search results of which a result count is indicated by extraction count data indicating an extraction count from the search results outputted from the outputting step.

A computer program for searching information according to the invention comprises steps of, extracting search conditions of a user from inputted information, loosing the search conditions of the user, creating loosed search conditions, performing a search based on the loosed search conditions, outputting first search results, adding divergence degrees to the first search results by use of the search conditions of the user and evaluation data for evaluating the search results, outputting the first search results added with the divergence degrees, classifying the first search results added with the divergence degrees by use of classification criterion data for classifying the search results on the basis of the divergence degrees, selecting second search results from among the classified first search results, outputting the second search results, determining a type of the user from the search conditions of the user by use of user type determination data for determining the type of the user, outputting a user type result, creating the search conditions containing a implicit request from the user type result by use of implicit request condition determination data for determining conditions implicitly requested by the user, searching the first search results on the basis of the search conditions containing the implicit request, outputting the search results containing the implicit request and extracting information, which is not contained in the second search results, from the search results containing the implicit request.

A computer program according to the invention, wherein the search condition contains at least one or more tuples of attributes possessed by a search target and information indicating the attributes, the loosed search condition contains at least one or more tuples of the attributes and information into which the information indicating the attributes is changed, information for determining the divergence degrees based on the information indicating attributes of the first search results and information indicating attributes contained in the search conditions of the user, is set in the evaluation data, the computer program comprises a step of adding the divergence degrees to the first search results based on the information for determining the divergence degrees, and thus outputting the first search results, the user type is set in the user type determination data in a way that associates the user type with the information indicating the attributes, the computer program comprises a step of outputting the user type in the user type determination data, associated with the information indicating the attribute contained in the search conditions of the user, and the implicit request condition is set in the implicit request condition determination data in a way that associates the implicit request condition with the user type result.

A computer program according to the invention, further comprises a step of extracting the search results of which a result count is indicated by extraction count data indicating an extraction count from the search results containing the implicit request that are outputted from the outputting step.

An information search method according to the invention comprises steps of, extracting search conditions of a user from inputted information, loosing the search conditions of the user, creating loosed search conditions, performing a search based on the loosed search conditions, outputting search results, adding divergence degrees to the search results by use of the search conditions of the user and evaluation data for evaluating the search results, outputting the search results added with the divergence degrees and classifying the search results added with the divergence degrees by use of classification criterion data for classifying the search results on the basis of the divergence degrees selecting the search result from among the classified search results and outputting the search result.

An information search method according to the invention, wherein the search condition contains at least one or more tuples of attributes possessed by a search target and information indicating the attributes, the loosed search condition contains at least one or more tuples of the attributes and information into which the information indicating the attributes is changed, the evaluation data contain information for determining the divergence degrees based on the information indicating attributes of the search results searched based on the loosed search conditions and information indicating attributes contained in the search conditions of the user, and the method comprises a step of adding the divergence degrees to the search results based on the information for determining the divergence degrees, and thus outputting the search results.

An information search method according to the invention comprises a steps of, extracting search conditions of a user from inputted information, determining a type of the user from the search conditions of the user by use of user type determination data for determining the type of the user from inputted information, outputting a user type result, creating the search conditions containing a implicit request from the user type result by use of implicit request condition determination data for determining conditions implicitly requested by the user, performing a search based on the search conditions containing the implicit request and outputting a search results.

An information search method according to the invention, wherein the search condition contains at least one or more tuples of attributes possessed by a search target and information indicating the attributes, the user type is set in the user type determination data in a way that associates the user type with the information indicating the attributes, the method comprises a step of outputting the user type in the user type determination data, associated with the information indicating the attribute contained in the search conditions of the user, and the implicit request condition is set in the implicit request condition determination data in a way that associates the implicit request condition with the user type result.

An information search method according to the invention, further comprises a step of extracting the search results of which a result count is indicated by extraction count data indicating an extraction count from the search results outputted from the outputting step.

An information search method according to the invention comprises steps of, extracting search conditions of a user from inputted information, loosing the search conditions of the user, creating loosed search conditions, performing a search based on the loosed search conditions, outputting first search results, adding divergence degrees to the first search results by use of the search conditions of the user and evaluation data for evaluating the search results, outputting the first search results added with the divergence degrees, classifying the first search results added with the divergence degrees by use of classification criterion data for classifying the search results on the basis of the divergence degrees, selecting second search results from among the classified first search results, outputting the second search results, determining a type of the user from the search conditions of the user by use of user type determination data for determining the type of the user, outputting a user type result, creating the search conditions containing a implicit request from the user type result by use of implicit request condition determination data for determining conditions implicitly requested by the user, searching the first search results on the basis of the search conditions containing the implicit request, outputting the search results containing the implicit request and extracting information, which is not contained in the second search results, from the search results containing the implicit request.

An information search method according to the invention, wherein the search condition contains at least one or more tuples of attributes possessed by a search target and information indicating the attributes, the loosed search condition contains at least one or more tuples of the attributes and information into which the information indicating the attributes is changed, information for determining the divergence degrees based on the information indicating attributes of the first search results and information indicating attributes contained in the search conditions of the user, is set in the evaluation data, the method comprises a step of adding the divergence degrees to the first search results based on the information for determining the divergence degrees, and thus outputting the first search results, the user type is set in the user type determination data in a way that associates the user type with the information indicating the attributes, the method comprises a step of outputting the user type in the user type determination data, associated with the information indicating the attribute contained in the search conditions of the user, and the implicit request condition is set in the implicit request condition determination data in a way that associates the implicit request condition with the user type result.

An information search method according to the invention, further comprises a step of extracting the search results of which a result count is indicated by extraction count data indicating an extraction count from the search results containing the implicit request that are outputted from the outputting step.

### BRIEF DESCRIPTION OF THE DRAWINGS

FIG. 1 is a diagram of a principle in a first embodiment of an information search device of the invention.

FIG. 2 is a diagram of the principle in the first embodiment of the information search device of the invention.

FIG. 3 is a flowchart of an operation in the first embodiment of the information search device of the invention.

FIG. 4 is a diagram of a system architecture in the first embodiment of the information search device of the invention.

FIG. 5 is a flowchart of a dialog between a user and a system in the first embodiment of the information search device of the invention.

FIG. 6 is a conceptual diagram of search condition data used in the first embodiment of the information search device of the invention.

FIG. 7A is a conceptual diagram of loosed condition data and loosed data of stations used in the first embodiment of the information search device of the invention.

FIG. 7B is a conceptual diagram of loosed condition data and loosed data of stations used in the first embodiment of the information search device of the invention.

FIG. 8 is a conceptual diagram of search target data used in the first embodiment of the information search device of the invention.

FIG. 9A is a conceptual diagram of evaluation data and house layout value data used in the first embodiment of the information search device of the invention.

FIG. 9B is a conceptual diagram of evaluation data and house layout value data used in the first embodiment of the information search device of the invention.

FIG. 10A is a conceptual diagram of classification criterion data used in the first embodiment of the information search device of the invention.

FIG. 10B is a conceptual diagram of classification criterion data used in the first embodiment of the information search device of the invention.

FIG. 10C is a conceptual diagram of classification criterion data used in the first embodiment of the information search device of the invention.

FIG. 10D is a conceptual diagram of classification criterion data used in the first embodiment of the information search device of the invention.

FIG. 10E is a conceptual diagram of classification criterion data used in the first embodiment of the information search device of the invention.

FIG. 10F is a conceptual diagram of classification criterion data used in the first embodiment of the information search device of the invention.

FIG. 11A is a conceptual diagram of market value/city type determination data and user type determination data used in the first embodiment of the information search device of the invention.

FIG. 11B is a conceptual diagram of market value/city type determination data and user type determination data used in the first embodiment of the information search device of the invention.

FIG. 12 is a conceptual diagram of implicit request condition determination data used in the first embodiment of the information search device of the invention.

FIG. 13 is a conceptual diagram of extraction count data used in the first embodiment of the information search device of the invention.

FIG. 14 is a flowchart of an operation in the first embodiment of the information search device of the invention.

FIG. 15 is a conceptual diagram of search results based on loosed conditions used in the first embodiment of the information search device of the invention.

FIG. 16 is a conceptual diagram of evaluated search results used in the first embodiment of the information search device of the invention.

FIG. 17 is a flowchart of an operation of a variation result output unit in the first embodiment of the information search device of the invention.

FIG. 18 is a flowchart of a similar result excluding process in the first embodiment of the information search device of the invention.

FIG. 19 is a conceptual diagram of similar result exclusion search results used in the first embodiment of the information search device of the invention.

FIG. 20A is a pint-of-view classification flowchart in the first embodiment of the information search device of the invention.

FIG. 20B is a conceptual diagram of pint-of-view classification results in the first embodiment of the information search device of the invention.

FIG. 21A is a divergence degree classification flowchart in the first embodiment of the information search device of the invention.

FIG. 21B is a conceptual diagram of the divergence degree classified results in the first embodiment of the information search device of the invention.

FIG. 22A is a flowchart of an operation of extracting the coincidence information from the classified results in the first embodiment of the information search device of the invention.

FIG. 22B is a conceptual diagram of point-of-view classified extraction results in the first embodiment of the information search device of the invention.

FIG. 23A is a flowchart of an operation of extracting partly coincident information from the classified results in the first embodiment of the information search device of the invention.

FIG. 23B is a conceptual diagram of divergence degree classified extraction results in the first embodiment of the information search device of the invention.

FIG. 24A is a conceptual diagram of variation search results in the first embodiment of the information search device of the invention.

FIG. 24B is a conceptual diagram of variation search results in the first embodiment of the information search device of the invention.

FIG. 24C is a conceptual diagram of variation search results in the first embodiment of the information search device of the invention.

FIG. 25 is a flowchart of an operation of a user type analogizing unit in the first embodiment of the information search device of the invention.

FIG. 26 is a flowchart of the operation of the user type analogizing unit in the first embodiment of the information search device of the invention.

FIG. 27 is a conceptual diagram of the search results containing a implicit request used in the first embodiment of the information search device of the invention.

FIG. 28 is a flowchart of the operation of an another-point-of-view information extraction unit in the first embodiment of the information search device of the invention.

FIG. 29 is a conceptual diagram of another-point-of-view information search results used in the first embodiment of the information search device of the invention.

FIG. 30A is a conceptual diagram of the search results used in the first embodiment of the information search device of the invention.

FIG. 30B is a conceptual diagram of the search results used in the first embodiment of the information search device of the invention.

FIG. 30C is a conceptual diagram of the search results used in the first embodiment of the information search device of the invention.

FIG. 30D is a conceptual diagram of the search results used in the first embodiment of the information search device of the invention.

FIG. 31 is a diagram of a principle in a second embodiment of the information search device of the invention.

FIG. 32 is a diagram of the principle in the second embodiment of the information search device of the invention.

FIG. 33 is a flowchart of an operation in the second embodiment of the information search device of the invention.

FIG. 34 is a flowchart of the operation in the second embodiment of the information search device of the invention.

FIG. 35 is a conceptual diagram of search results containing a implicit request in the second embodiment of the information search device of the invention.

FIG. 36 is a flowchart of an operation of an another-point-of-view information extraction unit in the second embodiment of the information search device of the invention.

FIG. 37 is a conceptual diagram of another-point-of-view information search results in the second embodiment of the information search device of the invention.

FIG. 38A is a conceptual diagram of the search results in the second embodiment of the information search device of the invention.

FIG. 38B is a conceptual diagram of the search results in the second embodiment of the information search device of the invention.

FIG. 38C is a conceptual diagram of the search results in the second embodiment of the information search device of the invention.

FIG. 38D is a conceptual diagram of the search results in the second embodiment of the information search device of the invention.

FIG. 39 is a diagram of a principle of the prior art.

FIG. 40 is a diagram of the principle of the prior art.

### DESCRIPTION OF THE PREFERRED EMBODIMENTS

### First Embodiment

A best mode for carrying out the invention will hereinafter be described with reference to the drawings.

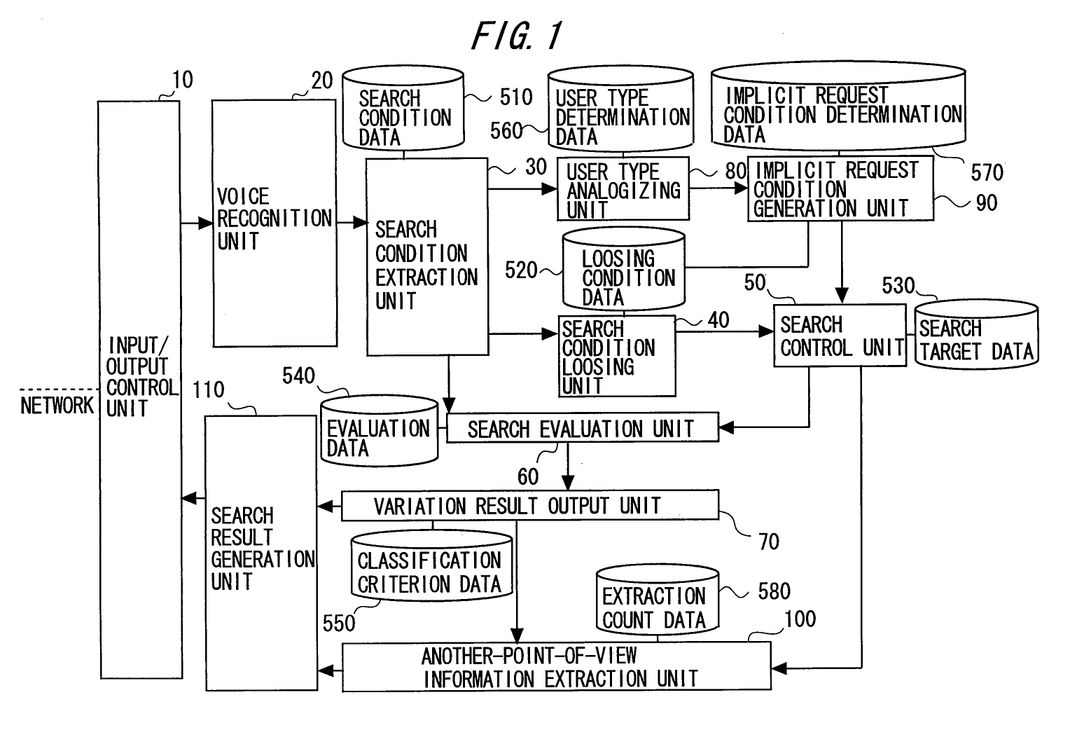

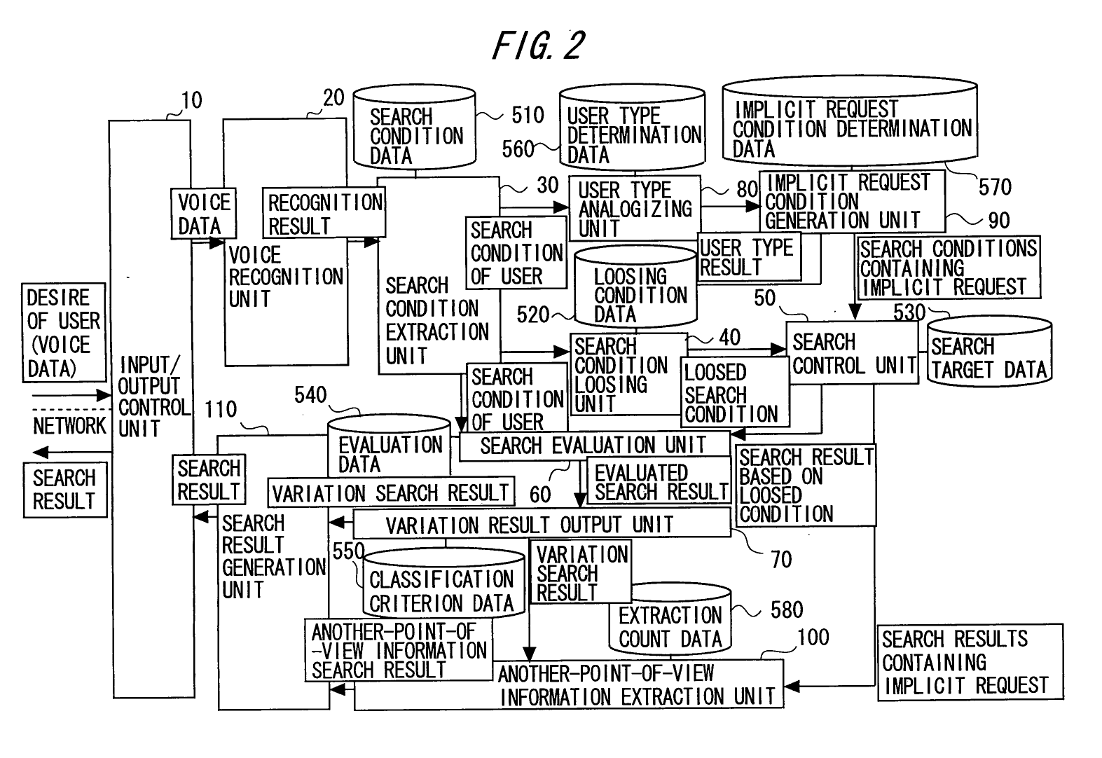

A configuration in each embodiment of an information search device of the invention is an exemplification, and the invention is not limited to the configurations of the embodiments. Further, in each of the following embodiments, a CPU cooperates with programs, whereby functions of respective units configuring the information search device of the invention are actualized. The invention is not, however, restricted to such a case, and part or the whole of the respective units configuring the information search device of the invention may also by actualized hardware. Moreover, the following description of each of the embodiments of the information search device according to the invention serves as a description of each of the embodiments of an information search program and of an information search method according to the invention. To start with, a first embodiment of the invention will be discussed with reference to FIGS. 1 and 2.

FIGS. 1 and 2 are diagrams showing a principle of the first embodiment of the information search device of the invention.

An input/output control unit 10 controls an interface between a user and a system. Then, the input/output unit 10 transfers voice data inputted by the user to a voice recognition unit 20. Moreover, the input/output control unit 10 receives a search result from a search result generation unit 110. Further, the input/output unit 10 provides the user with the search result.

The voice recognition unit 20 receives the voice data from the input/output unit 10. Then, the voice recognition unit 20 recognizes a voice of the voice data. Then, the voice recognition unit 20 transfers a recognition result to a search condition extraction unit 30. The search condition extraction unit 30 receives the recognition result from the voice recognition unit 20. Subsequently, the search condition extraction unit 30 extracts search conditions of the user by use of search condition data 510.

A search condition loosing unit 40 generates, from the search conditions of the user, loosed search conditions by loosing the search conditions of the user on the basis of loosing condition data 520. A search control unit 50 extracts a search result based on the loosed conditions coincident with the conditions from search target data 530 on the basis of the loosed search conditions received from the search condition loosing unit 40. Further, the search control unit 50 extracts a piece of search result information containing a implicit request on the basis of the search conditions containing the implicit request that has been received from a implicit request condition generation unit 90.

A search evaluation unit 60 adds points to the search results based on the loosing conditions by use of evaluation data 540. Then, the search evaluation unit 60 sorts out the search results in the sequence of the points, thus creating evaluated search results. A variation result output unit 70 creates, from the evaluated search results, a variation search result defined as information presented as a search result to the user on the basis of classification criterion data 550.

A user type analogizing unit 80 analogizes a type of the user from the search conditions of the user on the basis of user type determination data 560. Then, the user type analogizing unit 80 creates a user type result. A implicit request condition generation unit 90 generates search conditions containing a implicit request by use of the user type result and implicit request condition determination data 570.

An another-point-of-view information extraction unit 100 creates a should-be-presented-to-the-user result from the search result containing the implicit request on the basis of extraction count data 580. A search result generation unit 110 transfers a combination of the variation search result and the search result containing the implicit request to the input/output control unit 10.

Search condition data 510 are data used by the search condition extraction unit 30 in order to create the search conditions of the user from the recognition result recognized by the voice recognition unit 20. Loosing condition data 520 are data employed by the search condition loosing unit 40 in order to create loosed search conditions from the search conditions of the user.

Search target data 530 are date serving as a search target and used by the search control unit 50. Evaluation data 540 are data employed for evaluating the search result by the search evaluation unit 60. Classification criterion data 550 are data used for generating the variation search result by the variation result output unit 70.

User type determination data 560 are data used for analogizing the type of the user by the user type analogizing unit 80. Implicit request condition determination data 570 are data employed for creating the search condition containing the implicit request of the user by the implicit request condition generation unit 90. Extraction count data 580 are data used for extracting an another-point-of-view information search result of the user by the another-point-of-view information extraction unit 100.

[Operation]

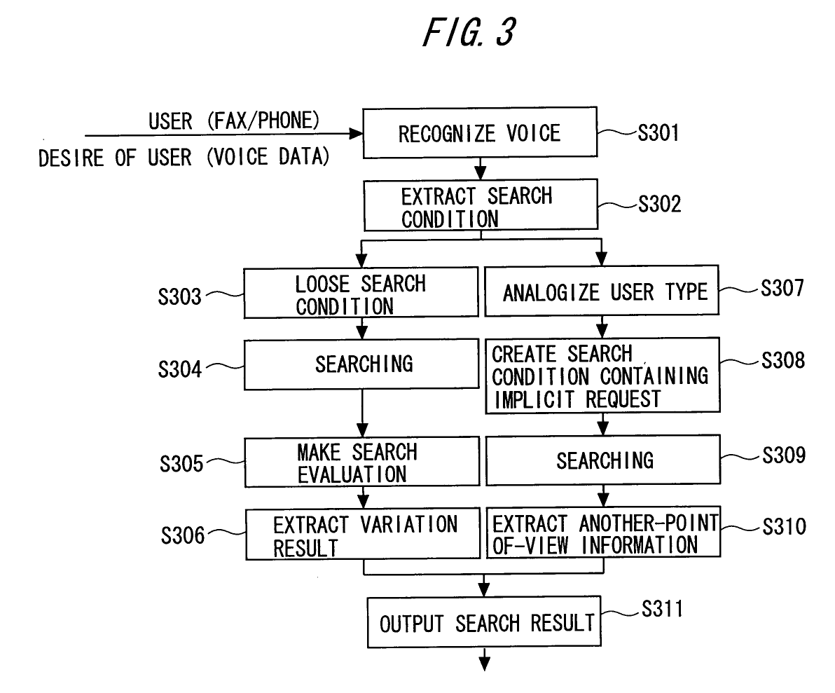

Next, an operation of the first embodiment of the information search device according to the invention will be explained with reference to a flowchart in FIG. 3 showing the operation of the first embodiment of the information search device of the invention and to FIGS. 1 and 2. The input/output control unit 10 receives a desire of the user via the voice data. Then, the input/output control unit 10 transfers the voice data to the voice recognition unit 20.

(Voice Recognition)

The voice recognition unit 20 receives the voice data from the input/output control unit 10. Subsequently, the voice recognition unit 20 performs voice recognition. Then, the voice recognition unit 20 creates a recognition result of the voice recognition. Subsequently, the voice recognition unit 20 transfers the recognition result to the search condition extraction unit 30 (S301).

(Extraction of Search Condition)

The search condition extraction unit 30 receives the recognition result. Then, the search condition extraction unit 30 creates the search conditions of the user by use of the search condition data 510. Subsequently, the search condition extraction unit 30 transfers the search conditions of the user to the search condition looseation unit 40, the search evaluation unit 60 and the user type analogizing unit 80 (S302).

(Looseation of Search Conditions)

The search condition looseation unit 40 receives the search conditions of the user. Then, the search condition looseation unit 40 looses the search conditions of the user on the basis of the loosed condition data 520 (S303). Subsequently, the search condition looseation unit 40 transfers a loosed search conditions to the search control unit 50.

(Search)

The search control unit 50 receives the loosed search conditions. Then, the search control unit 50 extracts information coincident with conditions in the loosed search conditions from the search target data 530. Subsequently, the search control unit 50 creates search results based on the loosed conditions. Then, the search control unit 50 transfers the search result based on the loosed conditions to the search evaluation unit 60 (S304).

(Search Evaluation)

The search evaluation unit 60 receives the search result based on the loosed conditions. Then, the search evaluation unit 60 adds a divergence degree defined as a degree of discrepancy to all pieces of information acquired as the search results based on the loosed conditions by use of the search conditions of the user and the evaluation data 540. Subsequently, the search evaluation unit 60 sorts out the search results in the sequence of the divergence degree from the lowest. Then, the search evaluation unit 60 transfers the evaluated search results to the variation result output unit 70 (S305).

(Extraction of Variation Result)

The variation result output unit 70 receives the evaluated search results. Then, the variation result output unit 70 classifies the evaluated search results based on the classification criterion data 550 for the purpose of not redundantly presenting similar pieces of information so that a broader range of information can be presented with brevity to the user.

Subsequently, the variation result output unit 70 extracts the information so as not to extract the similar information from the thus-classified evaluated search results. Then, the variation result output unit 70 creates the variation search results. Further, the variation result output unit 70 transfers the thus-created variation search results to the search result generation unit 110 (S306).

(Analogizing of User Type)

The user type analogizing unit 80 receives the search conditions of the user. Then, the user type analogizing unit 80 extracts market value data by use of the user type determination data 560. Then, the user type analogizing unit 80 determines a type of the user from a type of city where the nearest station designated as conditions of the user exists. Subsequently, the user type analogizing unit 80 creates a result of the user type. Then, the user type analogizing unit 80 transfers the thus-created user type result to the implicit request condition generation unit 90 (S307).

(Creation of Search Conditions Containing Implicit Request)

The implicit request condition generation unit 90 receives the user type result. Then, the implicit request condition generation unit 90 creates the search conditions containing the implicit request of the user on the basis of the implicit request condition determination data 570 and the loosing condition data 520. Subsequently, the implicit request condition generation unit 90 transfers the search conditions containing the implicit request to the search control unit 50 (S308).

(Search)

The search control unit 50 receives the search conditions containing the implicit request. Then, the search control unit 50 extracts, from the search target data 530, the information coincident with the conditions in the search conditions containing the implicit request. Subsequently, the search control unit 50 creates the search result containing the implicit request. Then, the search control unit 50 transfers the search result containing the implicit request to the another-point-of-view information extraction unit 100 (S309).

(Extraction of Another-Point-of-View Information)

The another-point-of-view information extraction unit 100 receives the search result containing the implicit request. Then, the another-point-of-view information extraction unit 100 creates an another-point-of-view information search result from the search result containing the implicit request on the basis of the extraction count data 580. Subsequently, the another-point-of-view information extraction unit 100 transfers the another-point-of-view information search result to the search result generation unit 110 (S310).

(Output of Search Result)

The search result generation unit 110 receives the variation search result and the another-point-of-view information search result. Then, the search result generation unit 110 organizes the variation search result and the another-point-of-view information search result so as to provide user-friendly visualize. Subsequently, the search result generation unit 110 transfers the variation search result and the another-point-of-view information search result as the search result to the input/output control unit 10 (S311). The input/output control unit 10 outputs the inputted search result to across a network.

Next, a real estate rental property information search service system for obtaining pieces of rental property information in such a way that the user accesses a voice information search service by phone, will hereinafter be exemplified by way of the first embodiment of the information search device of the invention. In this example, the user searches for the rental property information by setting conditions of three items such as a [rent], a [house layout] and the [nearest station). Then, the user acquires a result by FAX.

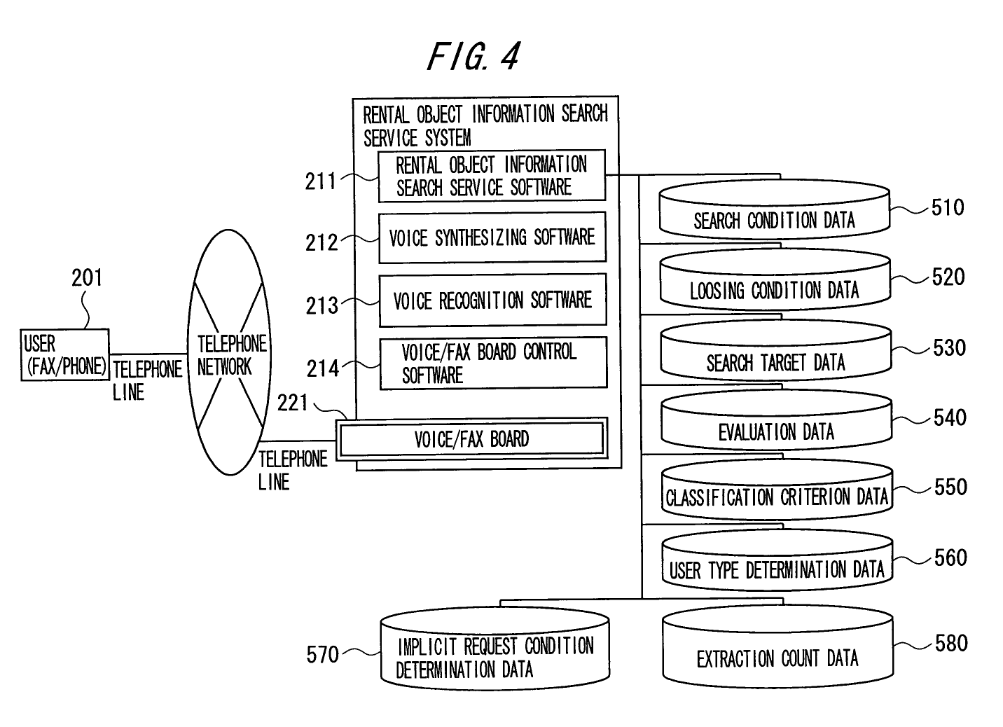

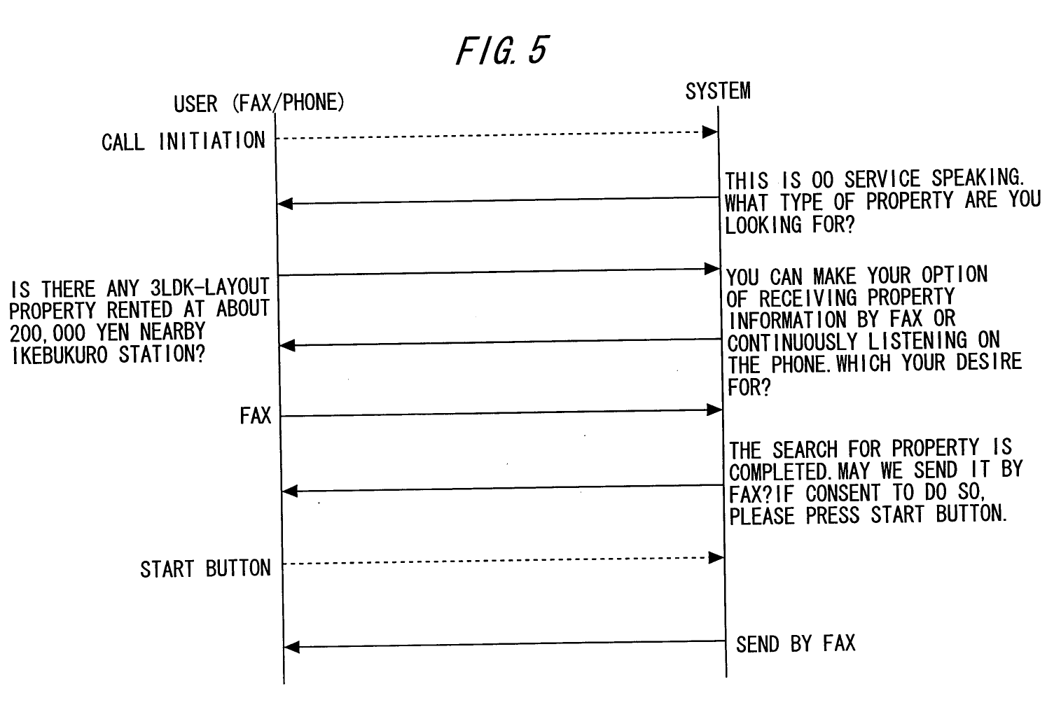

FIG. 4 shows a diagram of a system architecture in the first embodiment of the information search device of the invention. Further, FIG. 5 shows a user-to-system dialog flowchart in the first embodiment of the information search device of the invention.

The rental property information search service system is provided with an existing voice-related technology. Then, the rental property information search service system executes a voice dialog based process with the user. Subsequently, the rental property information search service system extracts the search conditions from a desire of the user. Then, the rental property information search service system searches for the rental property information. Then, the rental property information search service system provides the search result to the user.

An architecture of the rental property information search service system as a system utilizing the first embodiment of the information search device of the invention, will hereinafter be described with reference to FIG. 4. The rental property information search service system includes rental information search service software 211, voice synthesizing software 212, voice recognition software 213, voice/FAX board control software 214 and a voice/FAX board 221. Then, the rental property information search service system is connected via a telephone network to the users (FAX-telephones) 201.

The rental information search service software 211 manages the search target data 530 stored with pieces of search target property information, the search condition data 510 required for the search and for creating the search result, the loosing condition data 520, the evaluation data 540, the classification criterion data 550, the user type determination data 560, the implicit request condition determination data 570 and the extraction count data 580.

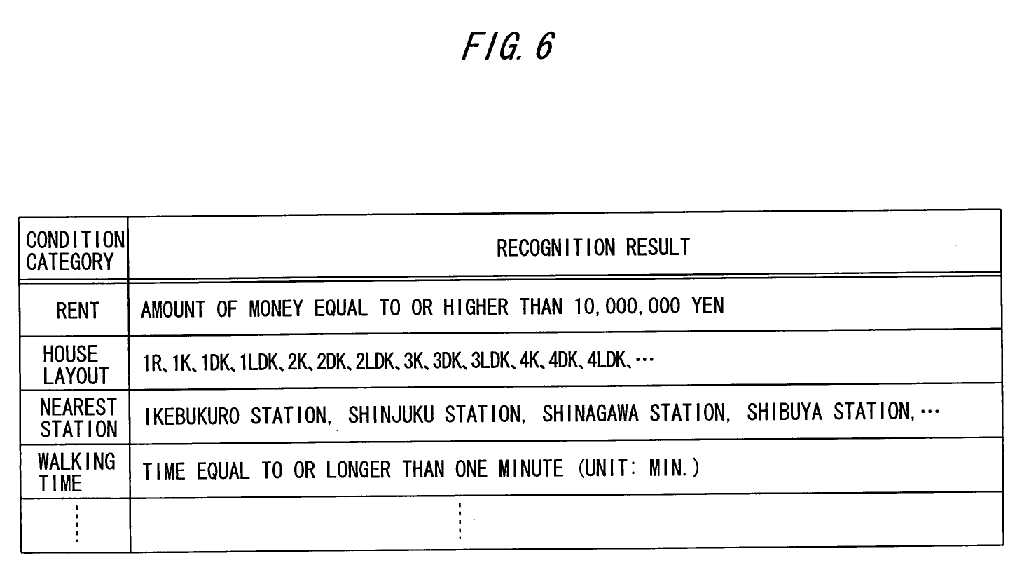

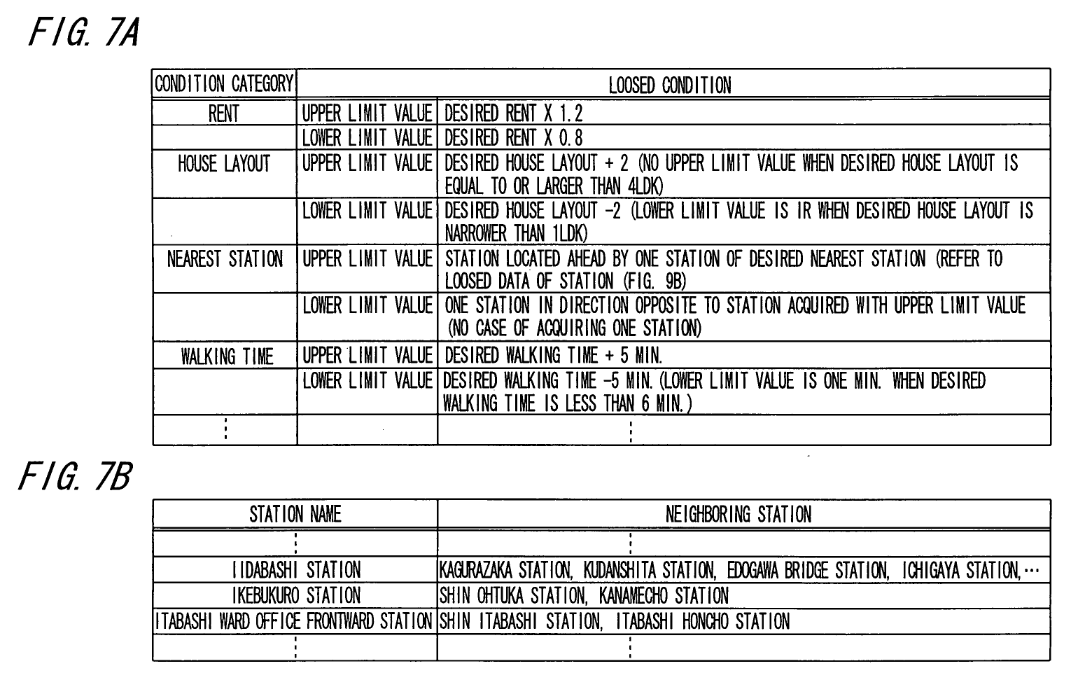

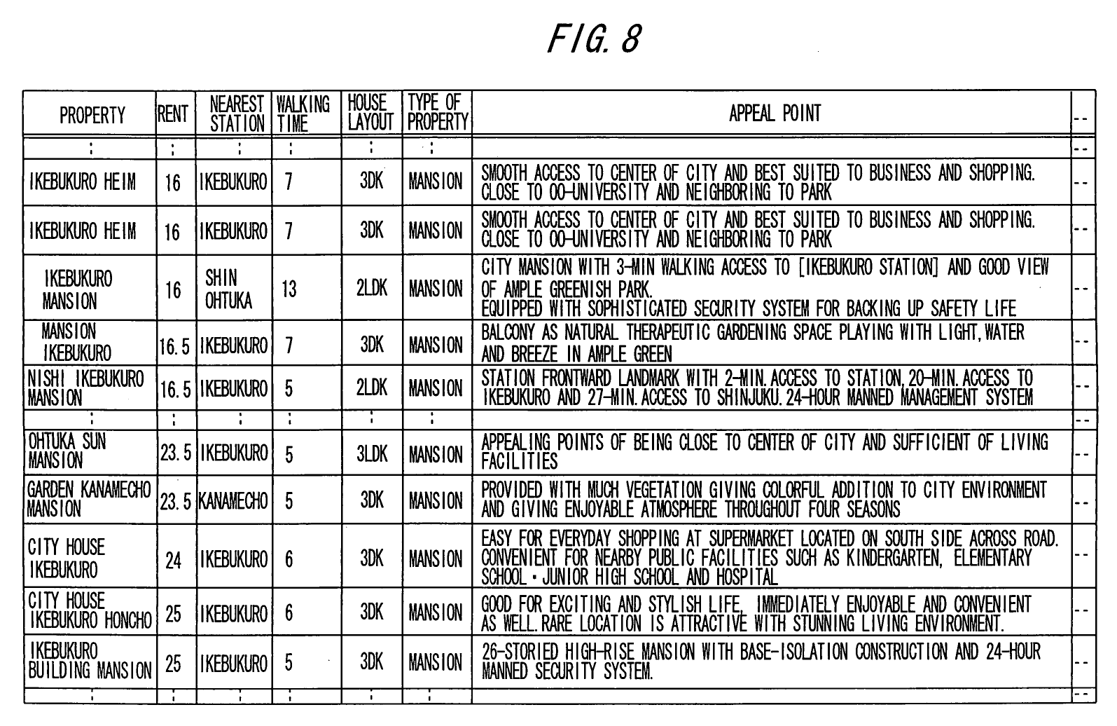

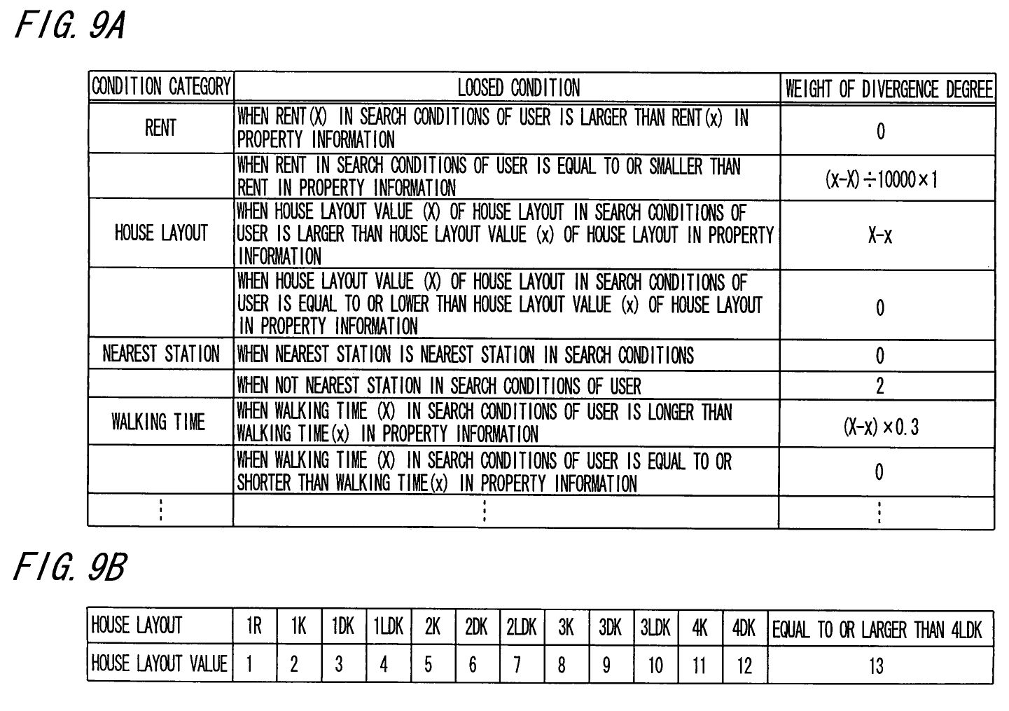

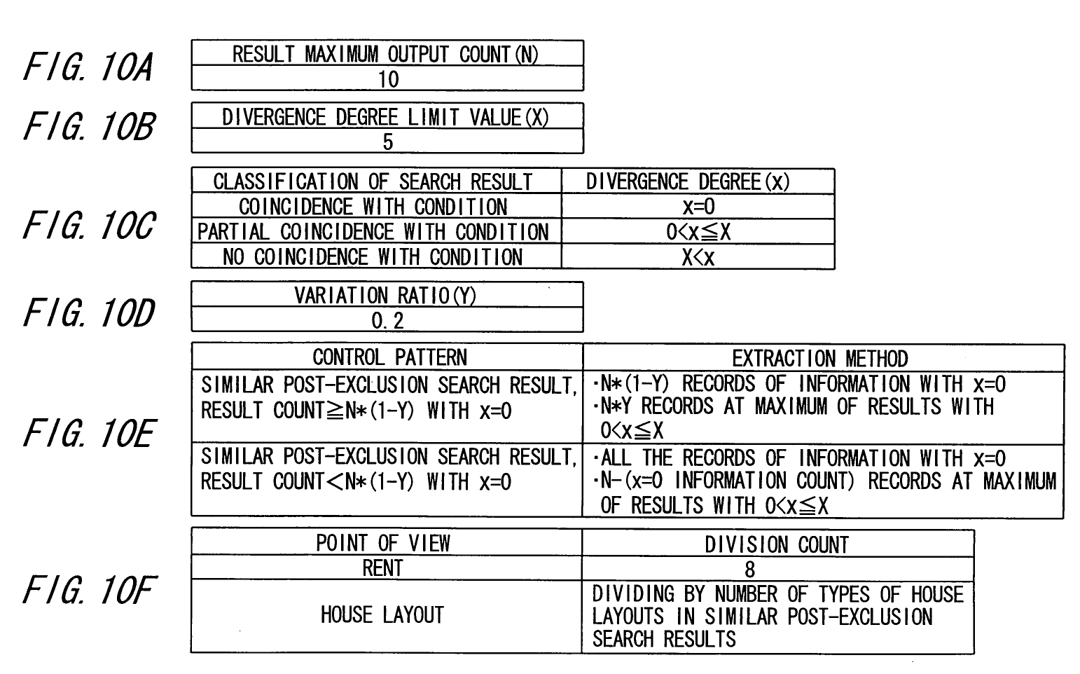

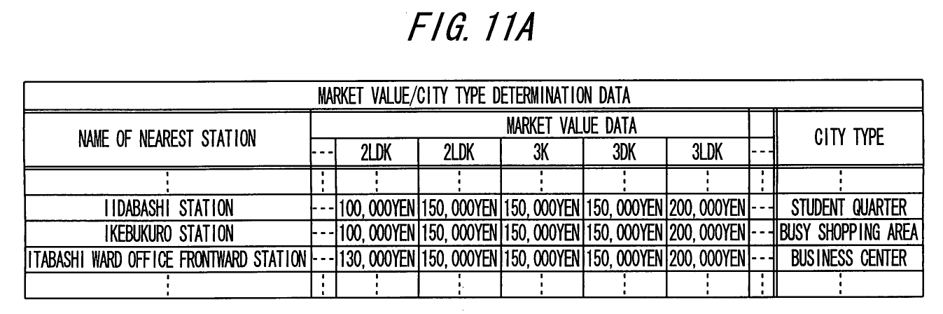

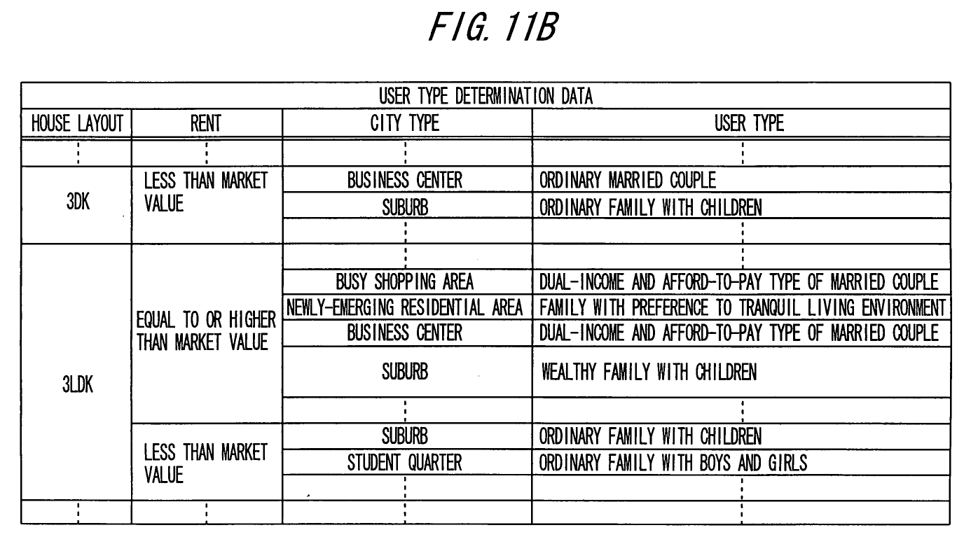

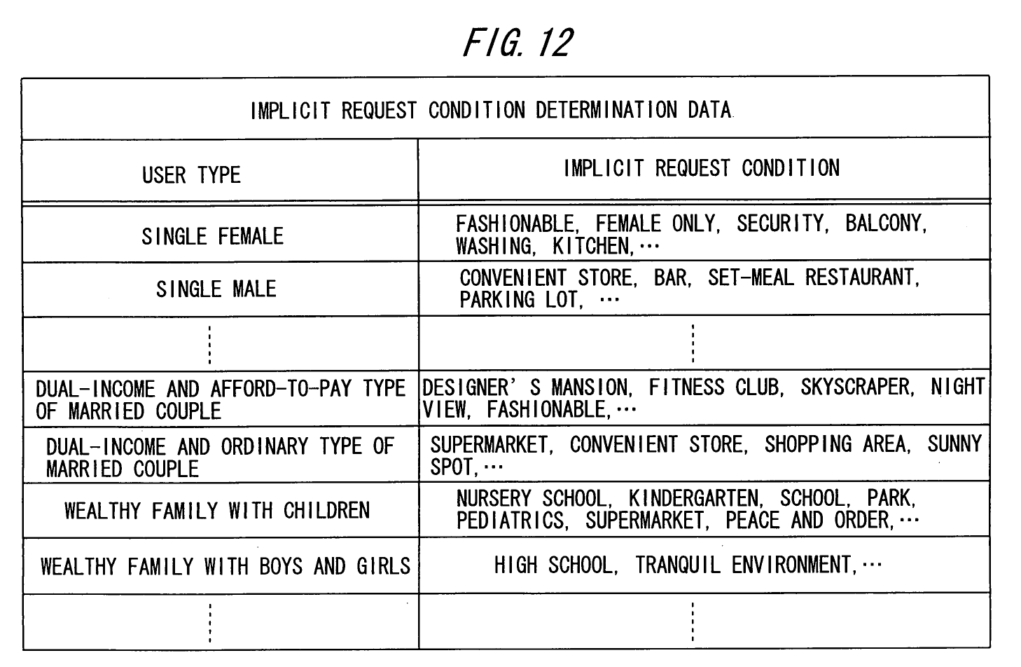

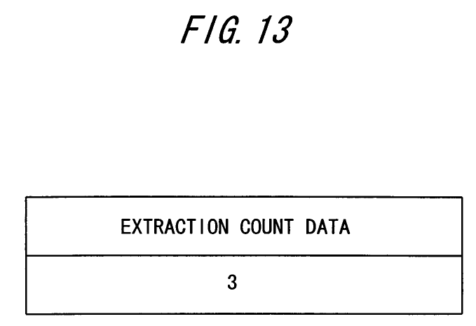

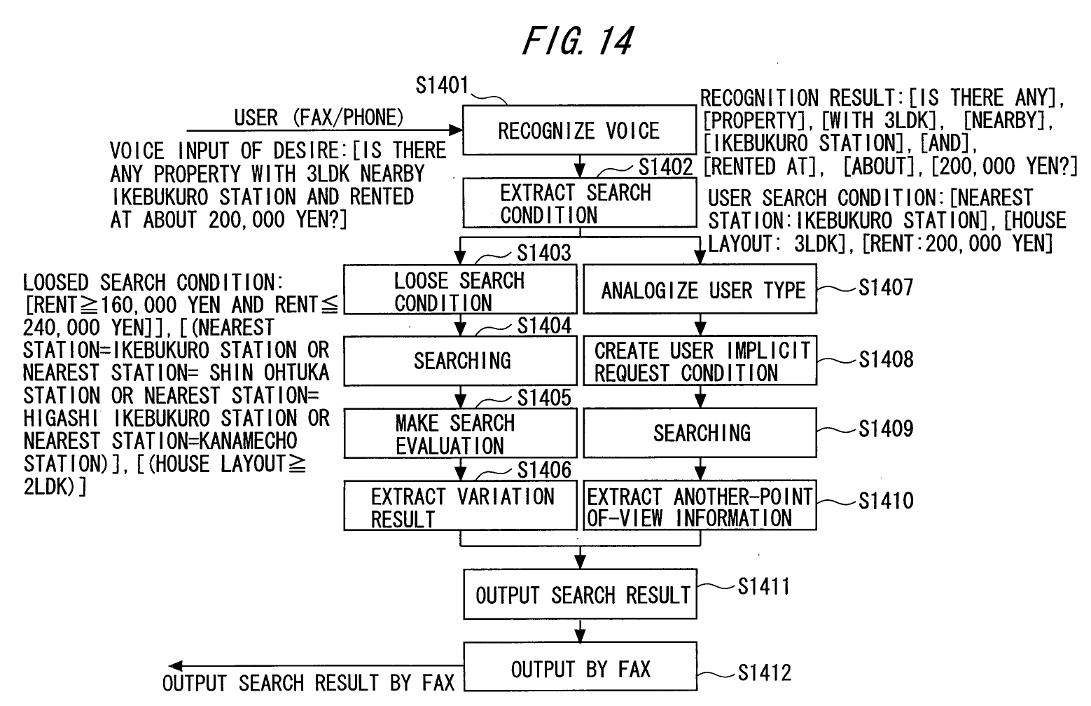

Further, FIG. 6 shows a conceptual diagram of the search condition data used in the first embodiment of the information search device of the invention. FIG. 7A and FIG. 7B shows a conceptual diagram of the loosing condition data and the loosed data of the stations, which are used in the first embodiment of the information search device of the invention. FIG. 8 shows a conceptual diagram of the search target data used in the first embodiment of the information search device of the invention. FIG. 9A and FIG. 9B shows a conceptual diagram of the evaluation data and house layout value data, which are used in the first embodiment of the information search device of the invention. FIG. 10A, FIG. 10B, FIG. 10C, FIG. 10D, FIG. 10E and FIG. 10F shows a conceptual diagram of the classification criterion data used in the first embodiment of the information search device of the invention. FIG. 11A and FIG. 11B shows a conceptual diagram of the market value/city type determination data and the user type determination data, which are used in the first embodiment of the information search device of the invention. FIG. 12 shows a conceptual diagram of the implicit request condition determination data used in the first embodiment of the information search device of the invention. FIG. 3 shows a conceptual diagram of the extraction count data used in the first embodiment of the information search device of the invention.

As shown in FIG. 5, the user gives a phone to the rental property information search service system. Thereupon, the rental property information search service system (which will hereinafter simply termed the system) answers such as [This is the 00 Service speaking. What type of property are you looking for?]. Then, the user speaks of conditions of a desired property like this: [Is there any property nearby Ikebukuro Station, rented at about 200,000 Yen and containing 3LDK?].

Next, the system gives a response such as [You can make your option of receiving the property information by FAX or continuously listening on the phone. Which option do you desire for?]. Then, the user speaks of the choice [FAX]. Next, the system replies such as [The search for the property is completed. May we send it by FAX? If consent to do so, please press the start button.]. Then, when the user presses the start button, the system faxes the information.

Next, a processing flow in the first embodiment of the information search device of the invention will be explained with reference to a flowchart of the operation in the first embodiment of the information search device of the invention and to FIG. 2 as well.

(Voice Recognition)

The voice recognition unit 20 receives the desire of [Is there any property nearby Ikebukuro Station, rented at about 200,000 Yen and containing 3LDK?] spoken of by the user. Then, the voice recognition unit 20 extracts phonemes such as [Is there any], [property], [nearby], [Ikebukuro Station], [rented at], [about], [200,000 Yen], [and], [containing], [3LDK], [?] as a recognition result. Subsequently, the voice recognition unit 20 transfers the recognition result to the search condition extraction unit 30 (S1401).

(Extraction of Search Conditions)

The search condition extraction unit 30 receives the recognition result. Then, the search condition extraction unit 30 creates the user's search conditions such as [Rent: 200,000 Yen], [Nearby station: Ikebukuro Station], [House layout: 3LDK] by use of the search condition data 510. Subsequently, the search condition extraction unit 30 transfers the search conditions of the user to the search condition loosing unit 40, the search evaluation unit 60 and the user type analogizing unit 80 (S1402).

(Looseation of Search Condition)

The search condition loosing unit 40 receives the search conditions of the user. Then, the search condition loosing unit 40 generates loosed search conditions by use of the loosing condition data 520 (S1403). According to the first embodiment, the search condition loosing unit 40 sets an upper limit value such as 200,000 Yen×1.2=240,000 Yen and a lower limit value such as 200,000 Yen×0.8=160,000 Yen on the basis of the condition [Rent] 200,000 Yen]. The search condition loosing unit 40 sets upper limit values such as [Shin Ohtsuka Station], [Higashi Ikebukuro Station] and a lower limit value such as [Kanamecho Station] on the basis of the condition [Nearby station: Ikebukuro Station]. The search condition loosing unit 40 sets a lower limit value to [2LDK] on the basis of the condition [House layout: 3LDK].

From the data given above, the search condition loosing unit 40 creates the loosed search conditions such as [the rent≧160,000 Yen and the rent≦240,000 Yen], [the nearest station=Ikebukuro Station or the nearest station=shin Ohtsuka Station or the nearest station=Higashi Ikebukuro Station or the nearest station=Kanamecho Station], [the house layout≧2LDK]. Then, the search condition loosing unit 40 transfers the created loosed conditions to the search control unit 50.

(Search)

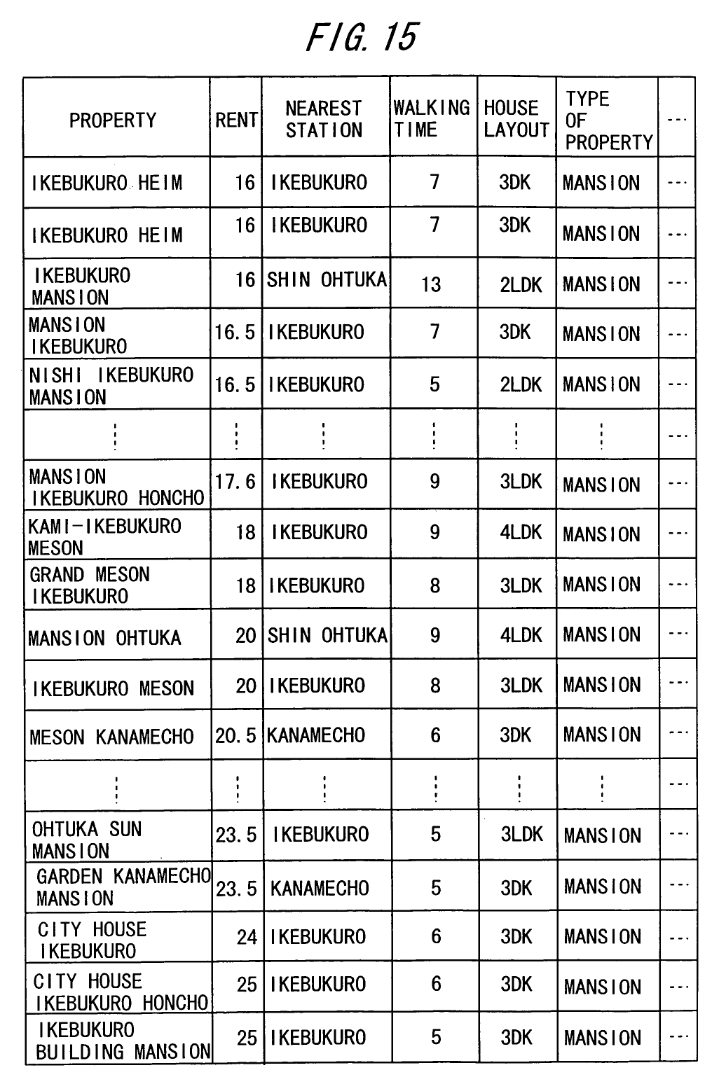

The search control unit 50 receives the loosed conditions. Then, the search control unit 50 generates [(the rent≧160,000 Yen and the rent≦240,000 Yen) and (the nearest station=Ikebukuro Station or the nearest station=Shin Ohtsuka Station or the nearest station=Higashi Ikebukuro Station or the nearest station=Kanamecho Station) and (the house layout≧2LDK)]. Subsequently, the search control unit 50 searches for the property information from the search target data 530. Then, the search control unit 50 acquires a search result based on the loosed conditions (S1404). Next, the search control unit 50 transfers the search result based on the loosed conditions to the search evaluation unit 60 (S1405). Herein, FIG. 15 shows a conceptual diagram of the search result based on the loosed conditions used in the first embodiment of the information search device of the invention.

(Search Evaluation)

The search evaluation unit 60 receives the search result based on the loosed conditions. Then, the search evaluation unit 60 calculates a divergence degree as a degree of discrepancy between the search conditions of the user and the property information acquired by the search result based on the loosed conditions by use of the search conditions of the user that have been received from the search condition extraction unit 70 and by use of the evaluation data 540 (S1405).

Herein, the search conditions of the user are [rent: 200,000 Yen], [the nearest station: Ikebukuro Station] and [house layout: 3LDK]. The search evaluation unit 60 calculates the divergence degree with respect to each piece of property information. The following is a method of calculating the divergence degree in a way that exemplifies the property information [Ikebukuro mansion, rent: 160,000 Yen, the nearest station: Shin Ohtuka Station, house layout: 2LDK] acquired from the search result based on the loosed conditions.

[Rent: 200,000 Yen] is given as one of the search conditions of the user, and [rent: 160,000 Yen] is obtained as the property information. Then, the rent shown as the search condition of the user is larger than the rent in the property information, and hence a weight of the divergence degree between the rents becomes 0. Next, another search condition of the user is [the nearest station: Ikebukuro Station], and the property information shows [the nearest station: Shin Ohtsuka Station]. The nearest station given as the search condition of the user and the nearest station shown in the property information are neighboring to each other. Therefore, the divergence degree between the nearest stations is weighted at 2.

The search evaluation unit 60 refers to the house layout value data. Then, the search evaluation unit 60, since the search condition of the user shows [house layout: 3LDK], sets a house value to 10 on the basis of the house layout value data. Further, the search evaluation unit 60, the property information being [house layout: 2LDK], sets the house layout value to 7. This house layout value indicates a narrower house layout than the search condition of the user shows. Therefore, the search evaluation unit 60 weights the divergence degree between the house layouts at 3 given by the formula such as (10−7)=3. Hence, the divergence degree of the property information is given 5 from the formula such as 0+2+3=5.

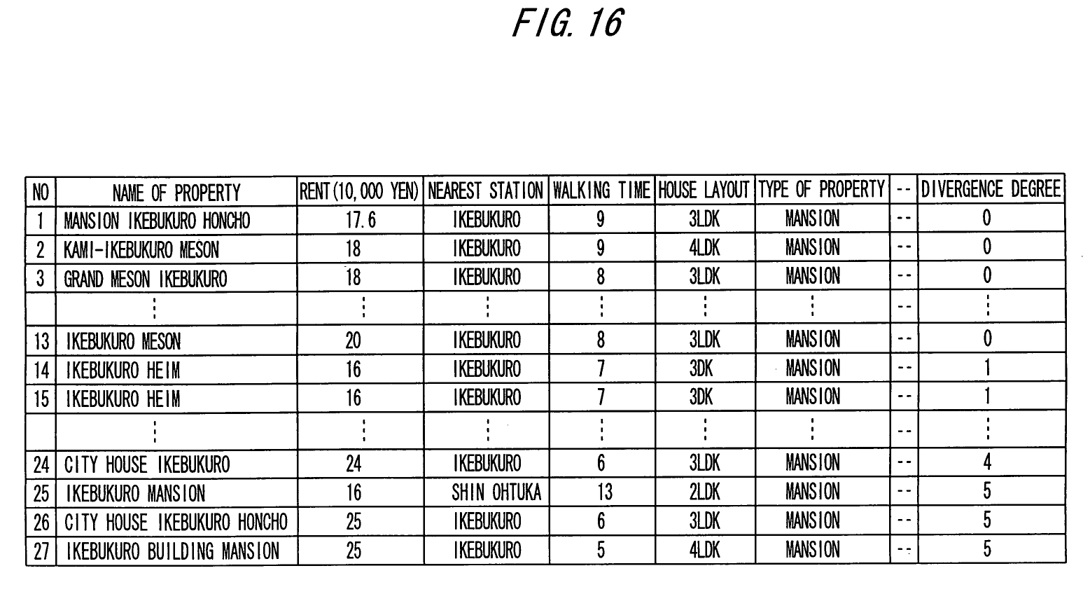

Thus, the search evaluation unit 60 calculates the degrees of divergence with respect to all the properties. Then, the search evaluation unit 60 sorts out the properties in the sequence of the divergence degree from the lowest. Subsequently, the search evaluation unit 60 transfers evaluated search results to the variation result output unit 70. Herein, FIG. 16 shows a conceptual diagram of the evaluated search results used in the first embodiment of the information search device of the invention.

(Output of Variation Result)

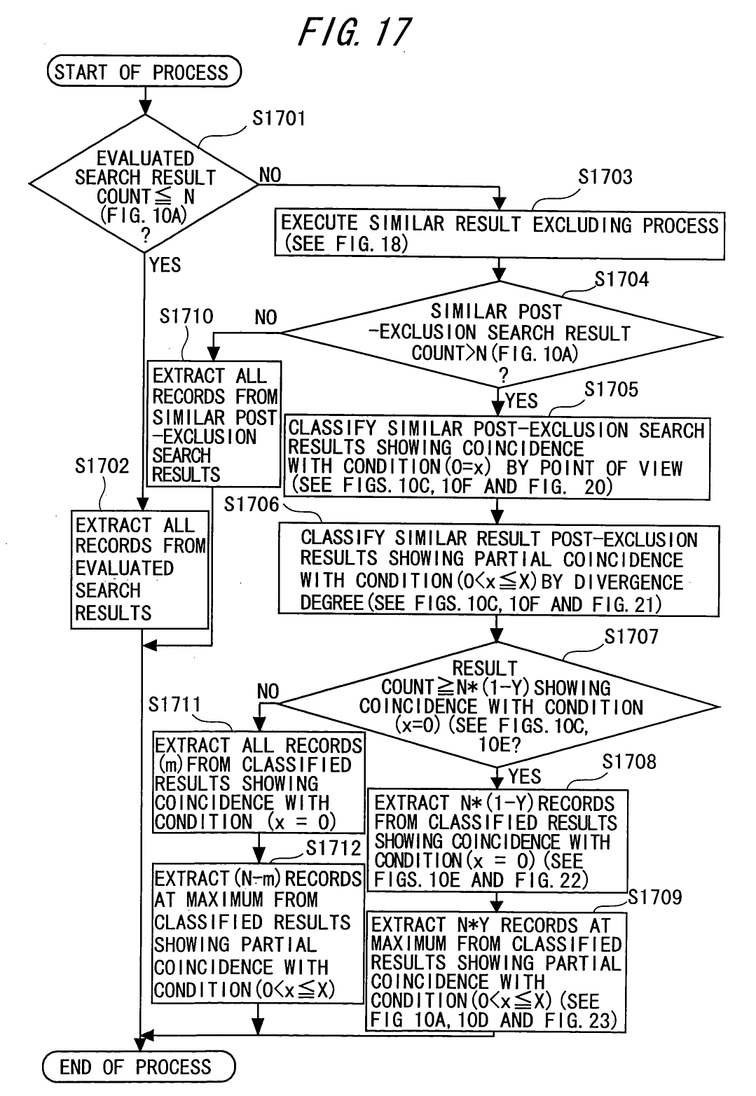

FIG. 17 shows a flowchart of an operation of the variation result output unit 70 in the first embodiment of the information search device of the invention. The variation result output unit 70 receives the evaluated search results. Then, the variation result output unit 70 compares a result maximum output count (FIG. 10A) in the classification criterion data 550 with a result count of the evaluated search results (S1701). The variation result output unit 70, if the result count of the evaluated search result is equal to or smaller than the result maximum output count (FIG. 10A), transfers all the evaluated search results as variation search results to the search result generation unit 110 (S1702).

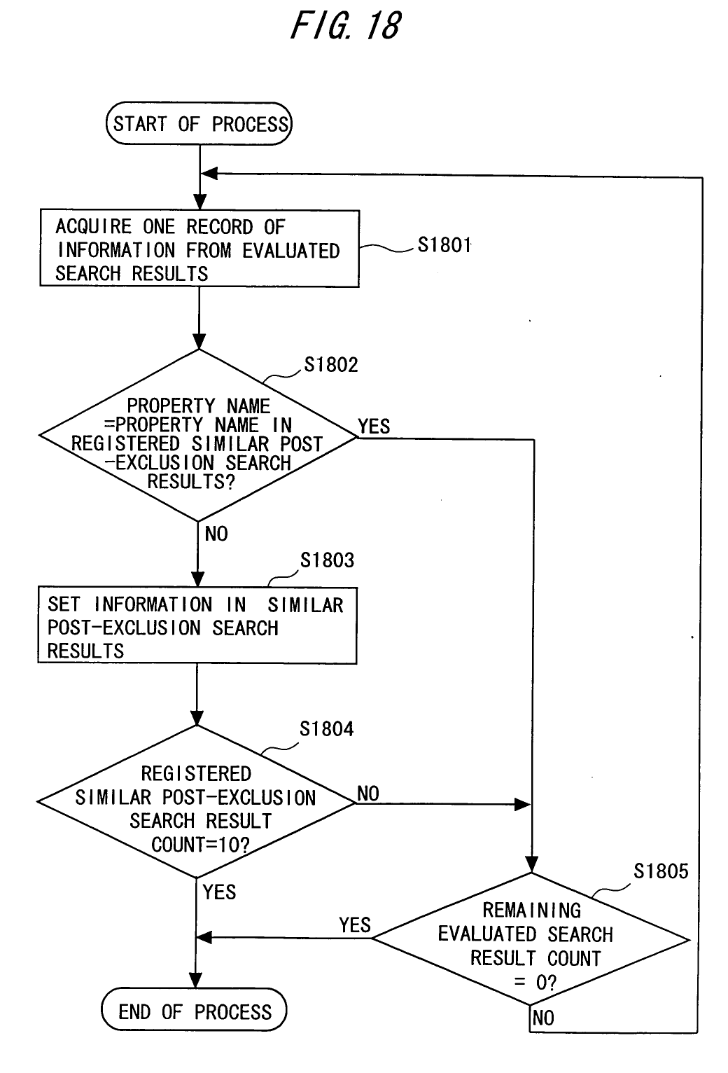

Further, the variation result output unit 70, when the result count of the evaluated search results is larger than the result maximum output count (FIG. 10A), executes a similar result excluding process in accordance with a flowchart of the similar result excluding process shown in FIG. 18 (S1703). FIG. 18 is the flowchart of the similar result excluding process in the first embodiment of the information search device of the invention.

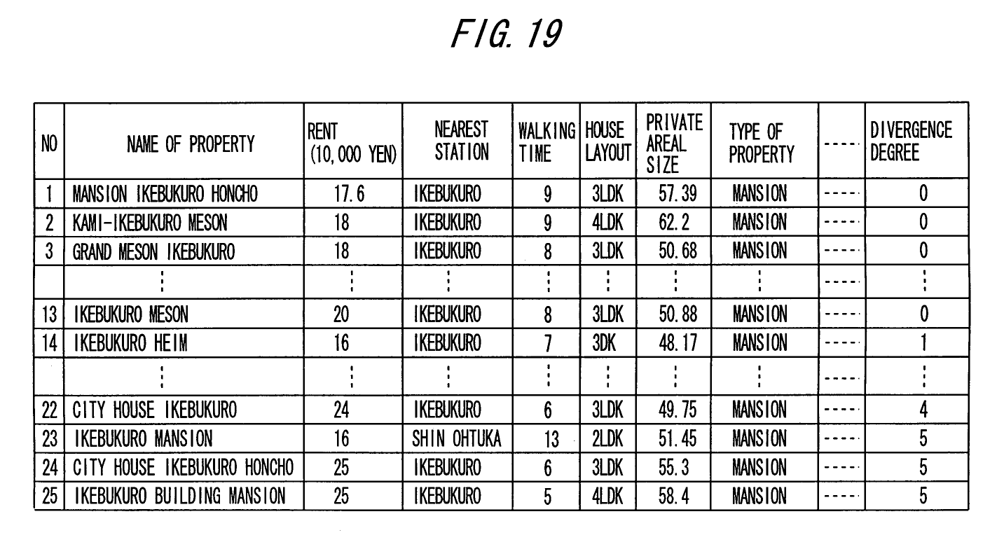

As shown in the flowchart in FIG. 18, the variation result output unit 70 acquires one record of information from the evaluation search results (S1801). Then, the variation result output unit 70 judges whether or not the property name is equal to an property name in registered similar post-exclusion search results (S1802). When the property name is equal to the property name in the registered similar post-exclusion search results, the variation result output unit 70 advances to S1805. When the property name is not equal to the property name in the registered similar post-exclusion search results, the variation result output unit 70 moves to S1803. Herein, the similar post-exclusion search results are, as shown in FIG. 19, a suite of search results after excluding the same search results. The registered similar post-exclusion search results are search results registered in the similar post-exclusion search results.

Next, the variation result output unit 70 sets the information in the similar post-exclusion search results (S1803). Subsequently, the variation result output unit 70 judges whether a registered similar post-exclusion search result count is equal to (=) 10 or not (S1804). When the registered similar post-exclusion search result count is equal to 10, the variation result output unit 70 terminates the process. When the registered similar post-exclusion search result count is not equal to 10, the variation result output unit 70 advances to S1805. The variation result output unit 70 judges whether a remaining evaluated search result count is equal to 0 or not. When the remaining evaluated search result count is not equal to 0, the variation result output unit 70 moves to S1801. When the remaining evaluated search result count is equal to 0, the variation result output unit 70 finishes the process.

As described above, when the evaluated search result count is larger than the result maximum output count (FIG. 10A), the variation result output unit 70 executes a similar result excluding process. In the similar result excluding process, the variation result output unit 70, if the same property name exists in the evaluated search results, one property is left in a way that excludes other properties. Then, the variation result output unit 70 creates the similar post-exclusion search results (FIG. 19). FIG. 19 is a conceptual diagram of the similar post-exclusion search results used in the first embodiment of the information search device of the invention.

When creating the similar post-exclusion search results, the variation result output unit 70 compares the result maximum output count (FIG. 10A) in the classification criterion data 550 with a result count of the similar post-exclusion search results (S1704). The variation result output unit 70, if the result count of the similar post-exclusion search results is equal to or smaller than the result maximum output count (FIG. 10A), transfers all the similar post-exclusion search results as variation search results to the search result generation unit 110 (S1710).

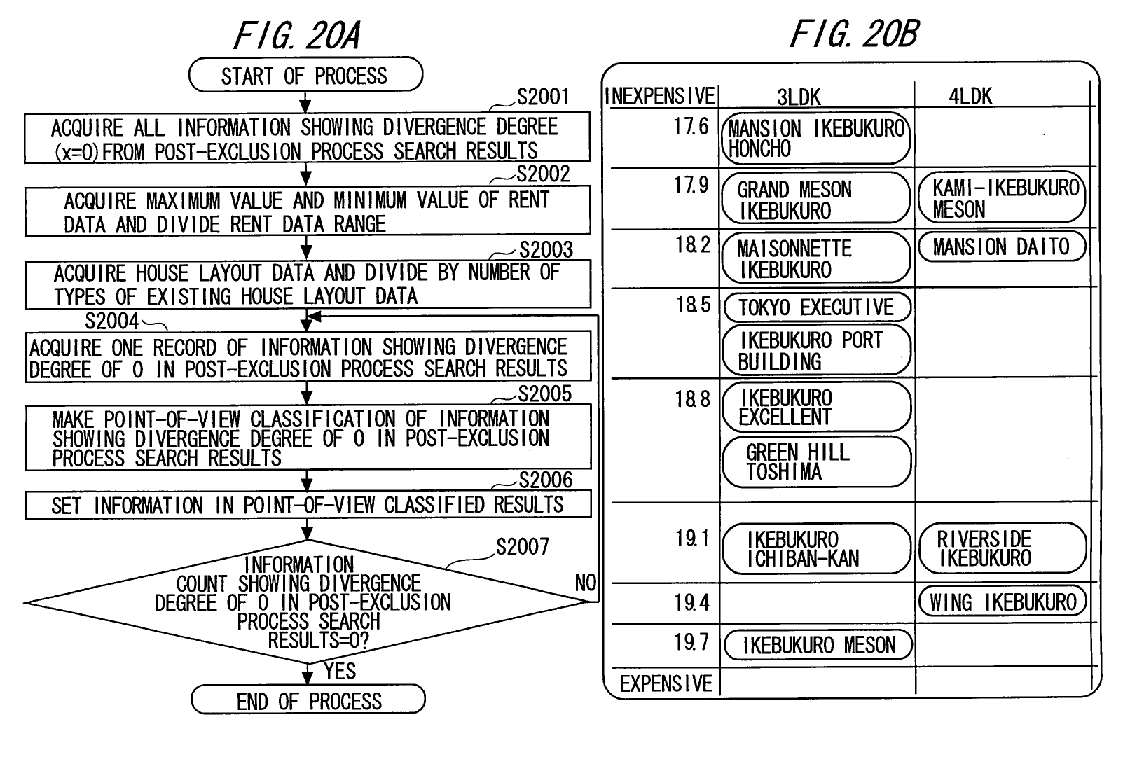

Further, the variation result output unit 70, when the result count of the similar post-exclusion search results is larger than the result maximum output count (FIG. 10A), classifies the similar post-exclusion search results in accordance with a pint-of-view classification flowchart shown in FIG. 20A (S1705). FIG. 20A is the pint-of-view classification flowchart in the first embodiment of the information search device of the invention. FIG. 20B is a conceptual diagram of pint-of-view classification results in the first embodiment of the information search device of the invention.

The variation result output unit 70, to start with, acquires all the search results exhibiting [the divergence degree: 0] in the similar post-exclusion search results (S2001). Then, the variation result output unit 70 acquires a maximum value and a minimum value of the rent data in the acquired search results (S2002). Herein, these values are given such as [the rent data maximum value: 200,000 Yen] and [the rent data minimum value: 160,000 Yen], and a division count related to the point of view in the classification criterion data 550 is 8 (FIG. 10F).

Further, the variation result output unit 70 effects dividing by the number of types of the house layout data, which exists in the house layout data of the acquired search results (S2003). Herein, the house layout data is given such as [the house layout data: 4LDK, 3LDK].

Then, the variation result output unit 70 acquires one record of information exhibiting the divergence degree of 0 in the post-exclusion process search results (S2004). Subsequently, the variation result output unit 70 classifies the search results showing the [divergence degree: 0] in the post-exclusion process search results (S2005). Subsequently, the variation result output unit 70 sets the information in point-of-view classified results (S2006). Then, the variation result output unit 70 judges whether an information count of the information showing the divergence degree of 0 in the post-exclusion process search results is 0 or not. Then, the variation result output unit 70 terminates the process when the information count of the information showing the divergence degree of 0 in the post-exclusion process search results is 0. The variation result output unit 70, when not 0, moves back to S2004. As a consequence, the variation result output unit 70 creates the point-of-view classified results as shown in FIG. 20B.

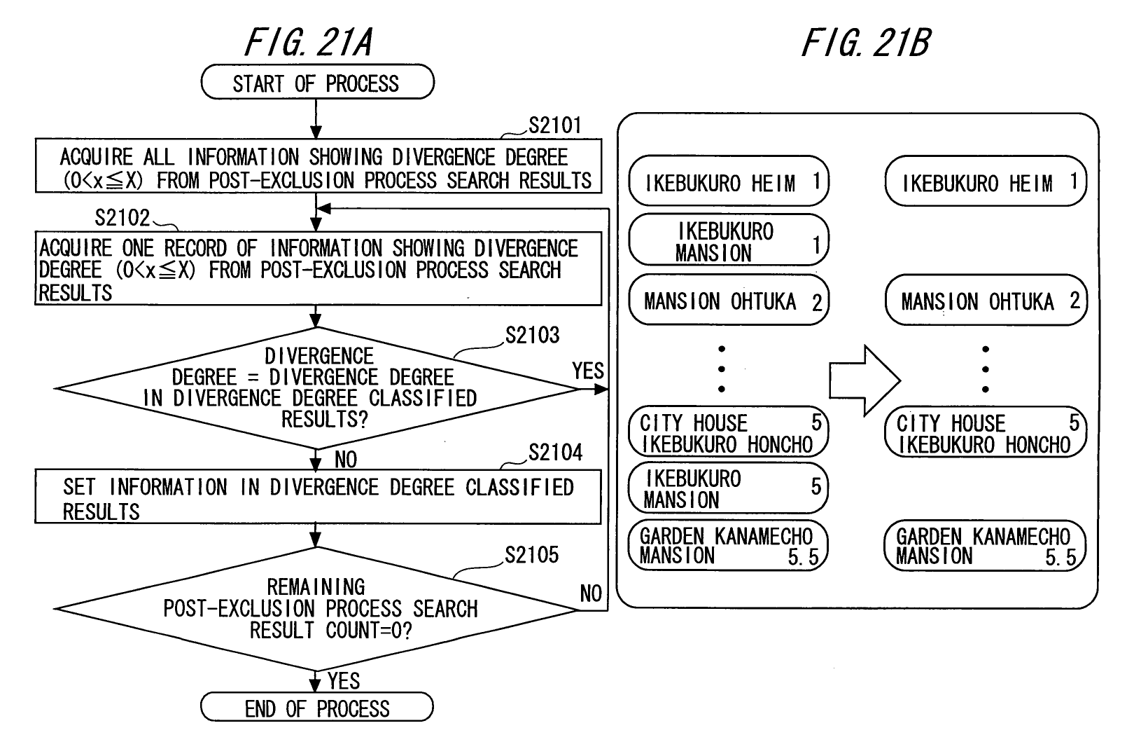

Next, the variation result output unit 70 acquires all the search results exhibiting the similar post-exclusion search result such as [0<divergence degree≦divergence degree limit value (which is herein 5)]. Then, the variation result output unit 70 executes a process of excluding the results having the same divergence degree from the acquired search results. Then, the variation result output unit 70 creates divergence degree classified results as shown in FIG. 21B. FIG. 21B is a conceptual diagram of the divergence degree classified results in the first embodiment of the information search device of the invention.

Namely, the variation result output unit 70 acquires, as shown in FIG. 21A, all the information exhibiting the divergence degree (0<x≦X) from the post-exclusion process search results (S2101). Next, the variation result output unit 70 acquires one record of information exhibiting the divergence degree (0<x≦X) from the post-exclusion process search results (S2102). Subsequently, the variation result output unit 70 judges whether or not the divergence degree is equal to a divergence degree in the divergence degree classified results (S2103). The variation result output unit 70, when the divergence degree is not equal to the divergence degree in the divergence degree classified results, advances to S2104. The variation result output unit 70, when the divergence degree is equal to the divergence degree in the divergence degree classified results, moves back to S2102. FIG. 21A is a divergence degree classification flowchart in the first embodiment of the information search device of the invention.

Then, the variation result output unit 70 sets the information in the divergence degree classified results (S2104). Subsequently, the variation result output unit 70 judges whether a remaining post-exclusion process search result count is equal to 0 or not (S2105). The variation result output unit 70 finishes the process when the remaining post-exclusion process search result count is equal to 0, but moves back to S2102 when the remaining post-exclusion process search result count is not equal to 0.

Next, the variation result output unit 70 judges, based on an associated relationship between the search result classification and the divergence degree shown in FIG. 10C and on an associated relationship between a control pattern, an extraction method and a division count shown in FIG. 10E, whether or not there is established a relationship that the result count with coincidence of the condition (x=0) is equal to or larger than N is a diagram of the principle of the prior art.(1−Y) (S1707).

Then, when there is not established the relationship that the result count with coincidence of the condition (x=0) is equal to or larger than N(1−Y), the variation result output unit 70 advances to S1711. When there is established the relationship that the result count with coincidence of the condition (x=0) is equal to or larger than N(1−Y), the variation result output unit 70 moves to S1708.

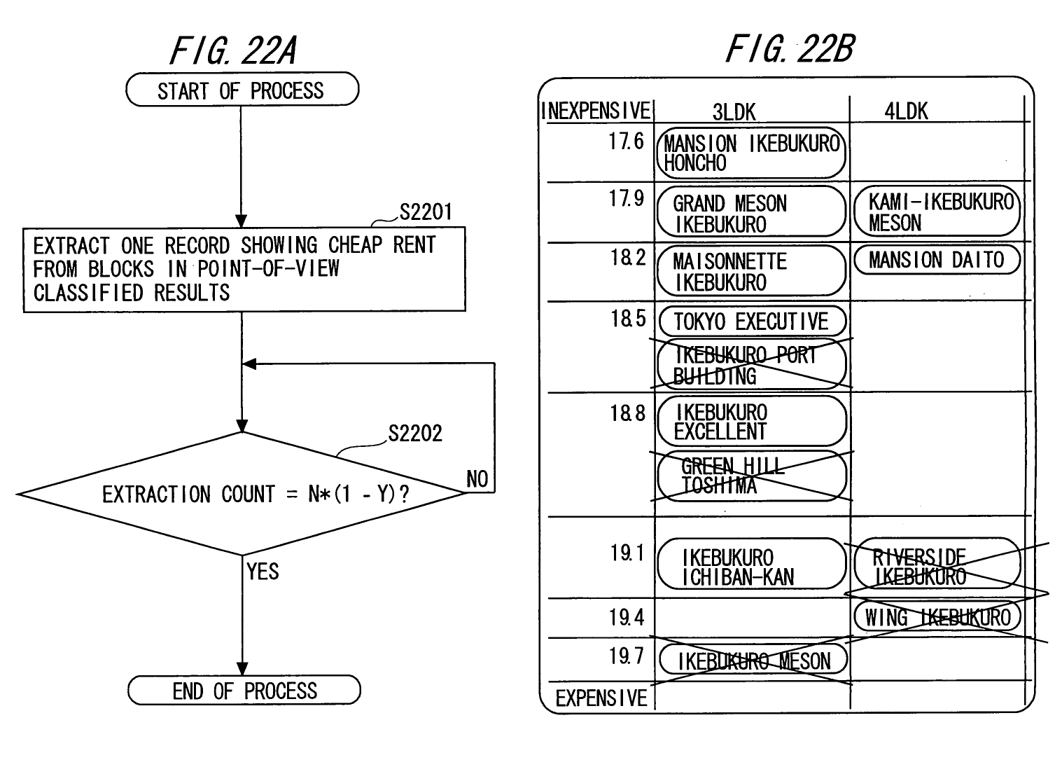

The variation result output unit 70, when the divergence degree classified results are created, acquires coincidence information from point-of-view classified results in the search results exhibiting such a similar post-exclusion search result that [the divergence degree: 0] in accordance with a flowchart in FIG. 22A for acquiring the coincidence information from the point-of-view classified results (S1708). FIG. 22A is the flowchart of an operation of extracting the coincidence information from the classified results in the first embodiment of the information search device of the invention. FIG. 22B is a conceptual diagram of point-of-view classified extraction results in the first embodiment of the information search device of the invention.

Namely, the variation result output unit 70 extracts one record showing a cheap rent out of respective blocks of the point-of-view classified results (S2201). Then, the variation result output unit 70 judges whether or not an extraction count is equal to N(1−Y) (S2202). The variation result output unit 70 terminates the process when the extraction count is equal to N(1−Y), but moves to S2201 when the extraction count is not equal to N(1−Y).

Herein, the variation result output unit 70 performs a calculation based on a calculation formula using a variation ratio (FIG. 10D) in the classification criterion data 550.

This calculation is expressed by 10×(1−0.2)=8. Then, the variation result output unit 70 extracts eight records of information at the maximum from the records exhibiting the inexpensive rents (S2201, S2202). Further, the variation result output unit 70 extracts one record showing the cheap rent from the respective blocks and therefore extracts the properties as seen in the point-of-view classified extraction results in FIG. 22B.

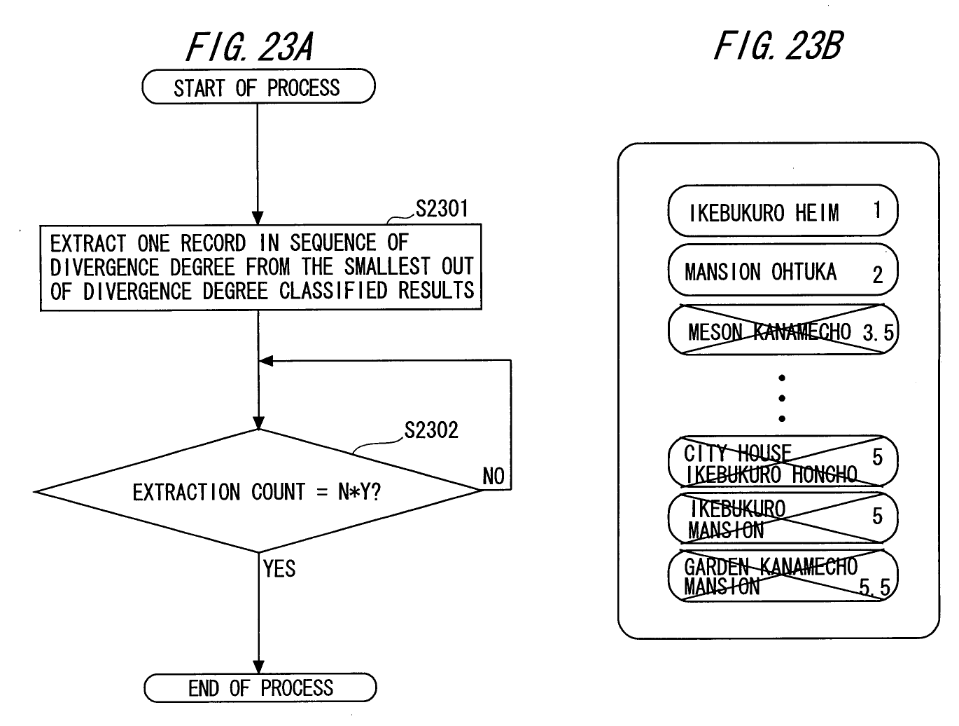

Moreover, the variation result output unit 70 acquires the properties from the divergence degree classified results in accordance with a flowchart in FIG. 23A (S1709). Herein, the variation result output unit 70 calculates the variation ratio (FIG. 10D) in the classification criterion data 550. Further, since the result count of the search results exhibiting the similar post-exclusion search result such as [the divergence degree: 0] is 10, an extraction count of the information is given by 10×0.2=2. Therefore, the variation result output unit 70 extracts two records of information. FIG. 23A is a flowchart of an operation of extracting partly coincident information from the classified results in the first embodiment of the information search device of the invention. FIG. 23B is a conceptual diagram of divergence degree classified extraction results in the first embodiment of the information search device of the invention.

Namely, the variation result output unit 70 extracts one records in the sequence of the divergence degree from the smallest out of the divergence degree classified results (S2301). Then, the variation result output unit 70 judges whether or not the extraction count=NY (S2302). Further, the variation result output unit 70 extracts one record showing the cheap rent from the respective blocks and therefore extracts the properties as seen in the divergence degree classified extraction results as seen in FIG. 23B.

When judging in S1707 that there is not established a relationship such as the result count showing coincidence with the condition (x=0) is equal to or larger than N(1−Y), the variation result output unit 70 moves to S1711. Then, the variation result output unit 70 extracts all the records (m) from the classified results showing the coincidence with the condition (x=0) (S1711). Subsequently, the variation result output unit 70 extracts (N−m) records from the classified results showing partial coincidence with the condition (0<x≦X), and finishes the process.

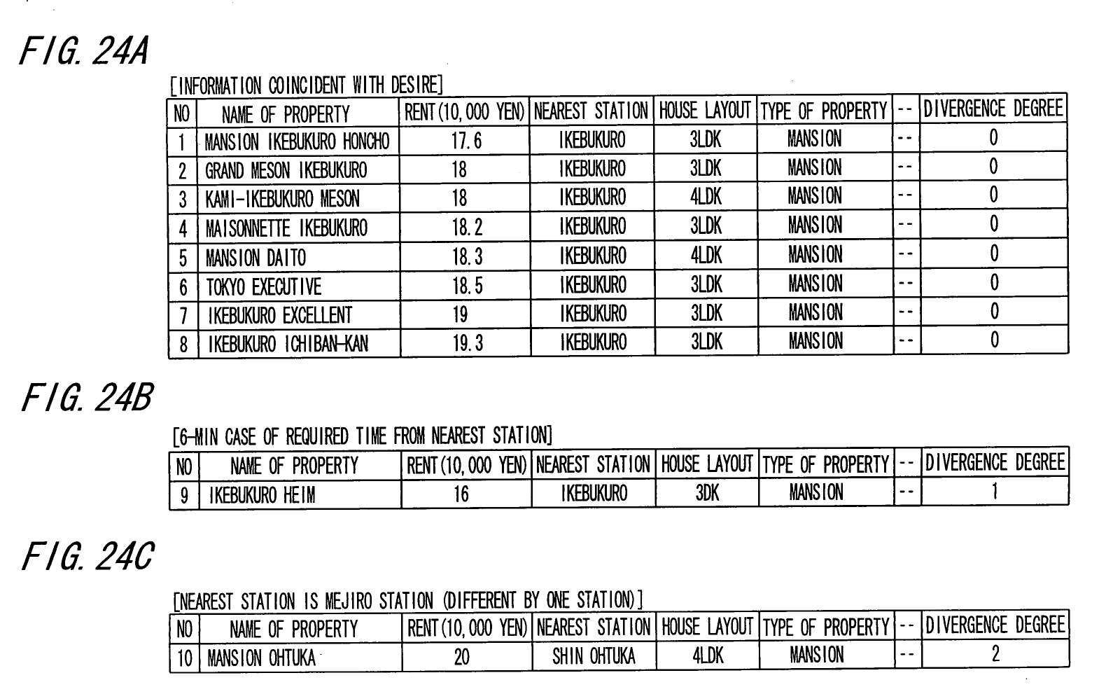

Next, the variation result output unit 70 combines the properties acquired from the point-of-view classified results with the properties acquired from the divergence degree classified results. Then, the variation result output unit 70 transfers the variation search result shown in FIG. 24 to the search result generation unit 110 (S1406). FIG. 24A, FIG. 24B and FIG. 24C shows a conceptual diagram of the variation search results in the first embodiment of the information search device of the invention. FIG. 24A shows the information coincident with the desire. FIG. 24B shows a case where it takes 6 min as the required time from the nearest station. FIG. 24C shows a case where the nearest station is Mejiro Station (different by one station).

(Analogizing of User Type)

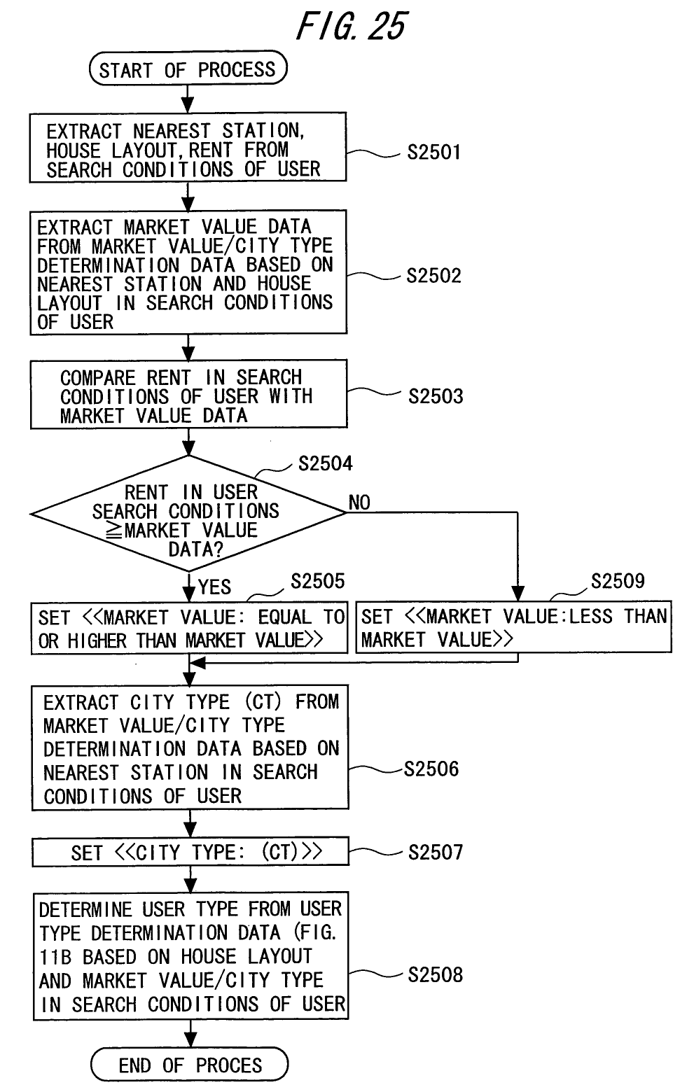

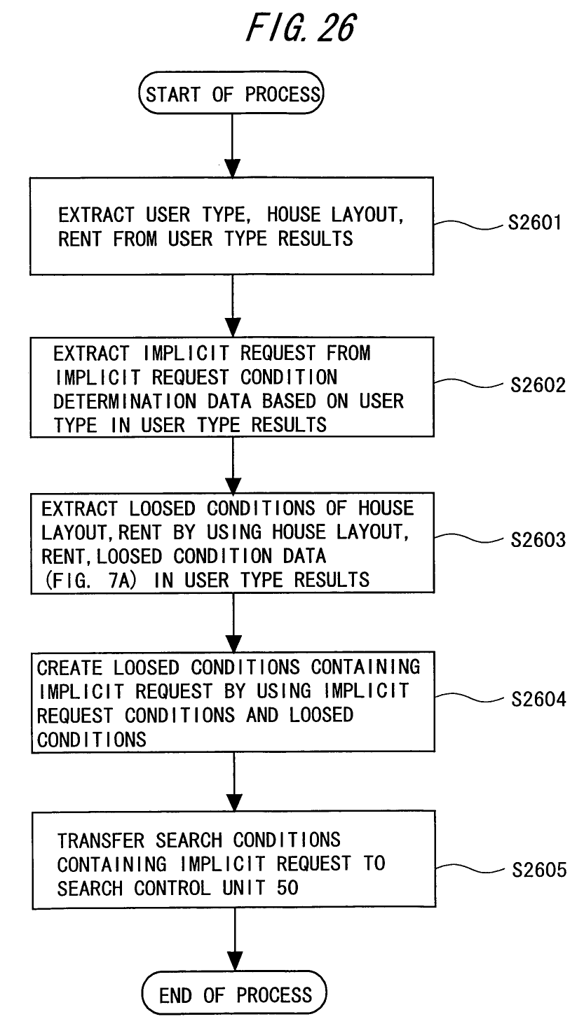

The user type analogizing unit 80 receives the search conditions of the user. Then, the user type analogizing unit 80 extracts market value data on the basis of the user type determination data 560. Subsequently, the user type analogizing unit 80 determines a type of the user from a type of the city around the nearest station in the conditions designated by the user. Then, the user type analogizing unit 80 creates a user type result. The created user type result is transferred to the implicit request condition generation unit 90. In detail, the operation is conducted in accordance with a flowchart in FIG. 25, showing the operation of the user type analogizing unit 80. FIG. 25 is a flowchart of the operation of the user type analogizing unit in the first embodiment of the information search device of the invention.

Herein, the search conditions of the user are given such as [rent: 200,000 Yen, the nearest station: Ikebukuro Station, the house layout: 3LDK]. The user type analogizing unit 80 extracts [the nearest station: Ikebukuro Station], [the house layout: 3LDK] and [rent: 200,000 Yen] from the search conditions of the user. Then, the user type analogizing unit 80 extracts [the market value data: 200,000 Yen] from the market value/city type determination data (FIG. 11A) on the basis of [the nearest station: Ikebukuro Station] and [the house layout: 3LDK].

Next, the user type analogizing unit 80 compares [the rent: 200,000 Yen] in the search conditions of the user with [the market value data: 200,000 Yen] extracted. Then, the user type analogizing unit 80, when the rent in the search conditions of the user is equal to or larger than the market value data, sets [the market value: equal to or higher than the market value]. Further, the user type analogizing unit 80 sets [the city type: a busy shopping area] from the market value/city type determination data (FIG. 11A) on the basis of the [the nearest station: Ikebukuro Station] in the search conditions of the user.

Next, the user type analogizing unit 80 determines the users as [a dual-income and afford-to-pay type of married couple] from the user type determination data (FIG. 11B) on the basis of [the house layout: 3LDK] set as the search condition of the user and [the market value: equal to or higher than the market value, the city type: the busy shopping area]. Then, the user type analogizing unit 80 creates a user type result such as [the user type: the dual-income and afford-to-pay type of married couple, the house layout: 3LDK, the rent: 200,000 Yen]. Subsequently, the user type analogizing unit 80 transfers the thus created user type result to the implicit request condition generation unit 90 (S1407).

Namely, the user type analogizing unit 80, as shown in FIG. 25, extracts the nearest station, the house layout and the rent from the search conditions of the user (S2501). Then, the user type analogizing unit 80 extracts, based on the nearest station and the house layout in the search conditions of the user, the market value data from the market value/city type determination data (S2502).

Then, the user type analogizing unit 80 compares the rent in the search conditions of the user with the market value data (S2503). Subsequently, the user type analogizing unit 80 judges whether the rent in the search conditions of the user is equal to or higher than the market value data. The user type analogizing unit 80 advances to S2505 when the rent in the search conditions of the user is equal to or higher than the market value data, and moves to S2509 when the rent in the search conditions of the user is neither equal to nor higher than the market value data.

The user type analogizing unit 80 sets the item of the market value as being equal to or higher than the market value in S2505. The user type analogizing unit 80 sets the item of the market value as being lower than the market value in S2509, and thereafter moves back to S2506. Then, the user type analogizing unit 80 extracts the city type (CT) from the market value/city data on the basis of the nearest station in the search conditions of the user (S2506).

Then, the user type analogizing unit 80 sets the city type to “CT” (S2507). Subsequently, the user type analogizing unit 80 determines the type of the user from the user type determination data (FIG. 11B) on the basis of the house layout, the market value and the city type in the search conditions of the user (S2508). Thereafter, the user type analogizing unit 80 finishes the process.

(Creation of Search Conditions Containing Implicit Request)

Next, the implicit request condition generation unit 90 receives the user type result. Then, the implicit request condition generation unit 90 extracts implicit request conditions by use of the implicit request condition determination data 570. Further, the implicit request condition generation unit 90 creates loosed conditions of the rent and of the house layout by use of the loosing condition data (FIG. 7A). Then, the implicit request condition generation unit 90 creates the search conditions containing the implicit request of the user on the basis of the implicit request conditions and the loosed conditions of the rent and the house layout. Subsequently, the implicit request condition generation unit 90 transfers the search conditions containing the implicit request to the search control unit 50. In detail, the operation is performed in accordance with a flowchart in FIG. 26, showing the operation of the implicit request condition generation unit. FIG. 26 is the flowchart of the operation of the implicit request condition generation unit in the first embodiment of the information search device of the invention.

Namely, the implicit request condition generation unit 90 extracts the user type, the house layout and the rent from the user type results (S2601). Then, the implicit request condition generation unit 90 extracts the implicit request conditions from the implicit request condition determination data on the basis of the user type in the user type results (S2602).

The implicit request condition generation unit 90 extracts the loosed conditions of the house layout and the rent by use of the house layout and the rent in the user type results and by use of the loosed condition data (FIG. 7A) (S2603). Then, the implicit request condition generation unit 90 creates the search conditions containing the implicit request on the basis of the implicit request conditions and the loosed conditions (S2604). Subsequently, the implicit request condition generation unit 90 transfers the search conditions containing the implicit request to the search control unit 50 (S2605). Thereafter, the implicit request condition generation unit 90 terminates the process.

The user type is assumed such as [the user type: the dual-income and afford-to-pay type of married couple, the house layout: 3LDK, the rent: 200,000 Yen]. The implicit request condition generation unit 90 determines the implicit request conditions such as [a designer's mansion, a fitness club, a skyscraper, a night view, being fashionable, . . . ] by use of the implicit request condition determination data 570 from [the user type: the dual-income and afford-to-pay type of married couple].

Further, the implicit request condition generation unit 90 creates, based on the loosed condition data (FIG. 7A), the loosed conditions of the rent and the house layout such as [(the rent≧160,000 Yen and the rent≦240,000 Yen), (the house layout≧2LDK)]. The implicit request condition generation unit 90 creates the search conditions containing the implicit request such as [(the rent≧160,000 Yen and the rent≦240,000 Yen) and (the house layout≧2LDK) and (the designer's mansion or the fitness club or the skyscraper or the a night view or being fashionable or, . . . )] (S1408).

(Search)

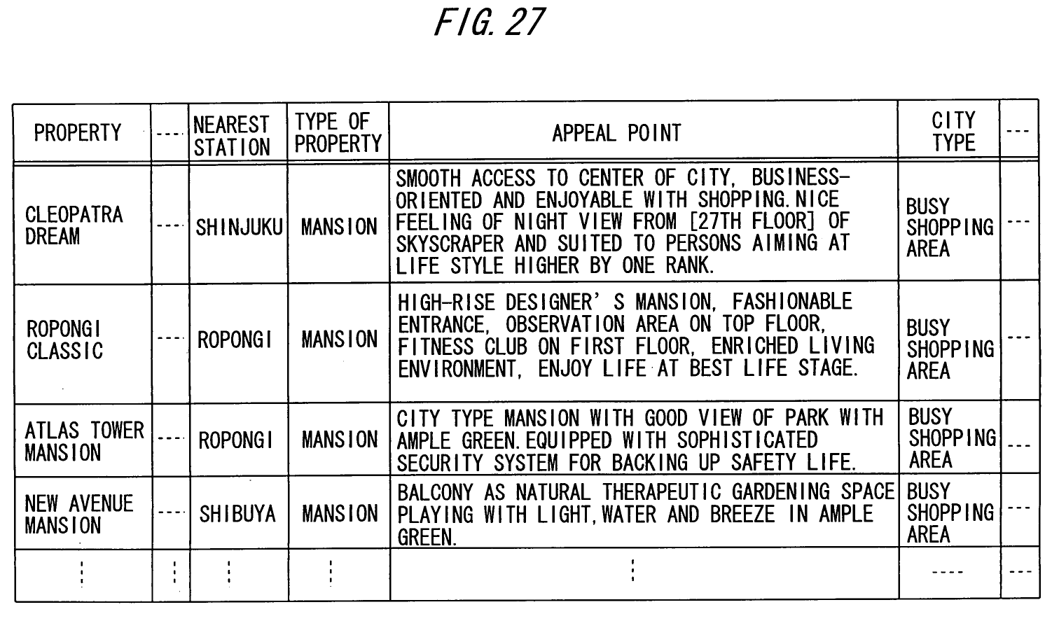

The search control unit 50 receives the search conditions containing the implicit request. Then, the search control unit 50 extracts from the search target data 530 a piece of information that meets the condition in the search conditions containing the implicit request. Subsequently, the search control unit 50 creates the search results containing the implicit request. Then, the search control unit 50 transfers the search results containing the implicit request to the another-point-of-view information extraction unit 100 (S1409). Herein, FIG. 27 shows a conceptual diagram of the search results containing the implicit request used in the first embodiment of the information search device of the invention.

(Extraction of Another-Point-of-View Information)

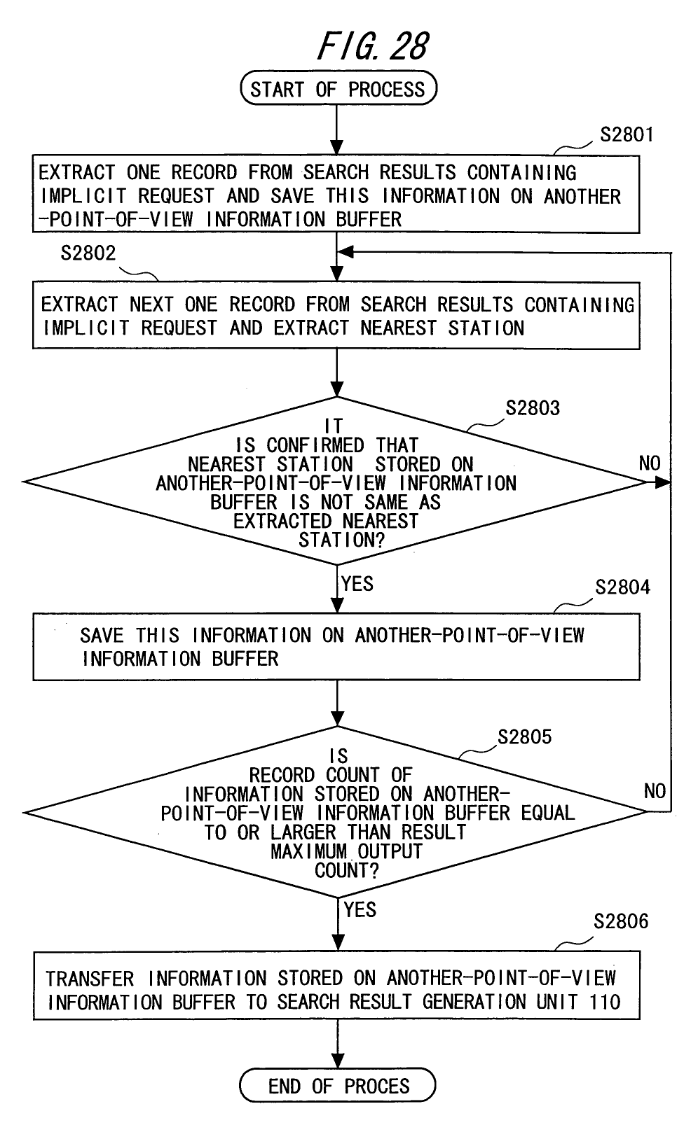

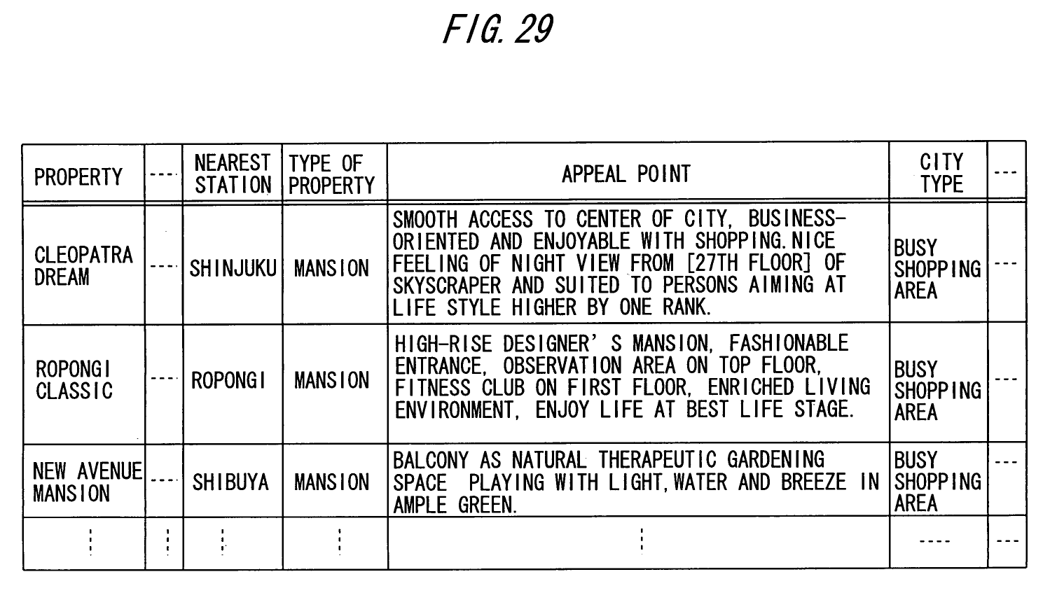

The another-point-of-view information extraction unit 100 receives the search results containing the implicit request. Then, the another-point-of-view information extraction unit 100 extracts information in accordance with a flowchart of the another-point-of-view information extraction unit in FIG. 28 by use of the extraction count data 580 from the search results containing the implicit request. FIG. 28 is the flowchart of an operation of the another-point-of-view information extraction unit in the first embodiment of the information search device of the invention. Then, the another-point-of-view information extraction unit 100 creates another-point-of-view information search results. Subsequently, the another-point-of-view information extraction unit 100 transfers the another-point-of-view information extraction search results to the search result generation unit 110 (S1410). Herein, FIG. 29 shows a conceptual diagram of the another-point-of-view information extraction search results utilized in the first embodiment of the information search device of the invention.

Namely, the another-point-of-view information extraction unit 100 extracts one record from the search results containing the implicit request, and stores this one record of information on an another-point-of-view information buffer (S2801). Then, the another-point-of-view information extraction unit 100 extracts next one record from the search results containing the implicit request, and extracts the nearest station (S2802).

Then, the another-point-of-view information extraction unit 100 checks whether or not the nearest station in the information stored on the another-point-of-view information buffer is the same as the extracted nearest station (S2803). Subsequently, when the nearest station in the information stored on the another-point-of-view information buffer is not the same as the extracted nearest station, the another-point-of-view information extraction unit 100 advances to S2804. When the nearest station in the information stored on the another-point-of-view information buffer is the same as the extracted nearest station, the another-point-of-view information extraction unit 100 moves back to S2802.

Then, the another-point-of-view information extraction unit 100 stores the information about the extracted nearest station on the another-point-of-view information buffer (S2804). Subsequently, the another-point-of-view information extraction unit 100 judges whether or not a record count of the information stored on the another-point-of-view information buffer is equal to or larger than a result maximum output count. The another-point-of-view information extraction unit 100 advances to S2806 when the record count of the information stored on the another-point-of-view information buffer is equal to or larger than the result maximum output count, but moves back to S2802 when the record count of the information stored on the another-point-of-view information buffer is neither equal to nor larger than the result maximum output count. Then, the another-point-of-view information extraction unit 100 transfers the information stored on the another-point-of-view information buffer to the search result generation unit 110 (S2806). Thereafter, the another-point-of-view information extraction unit 100 terminates the process.

(Output of Search Result)

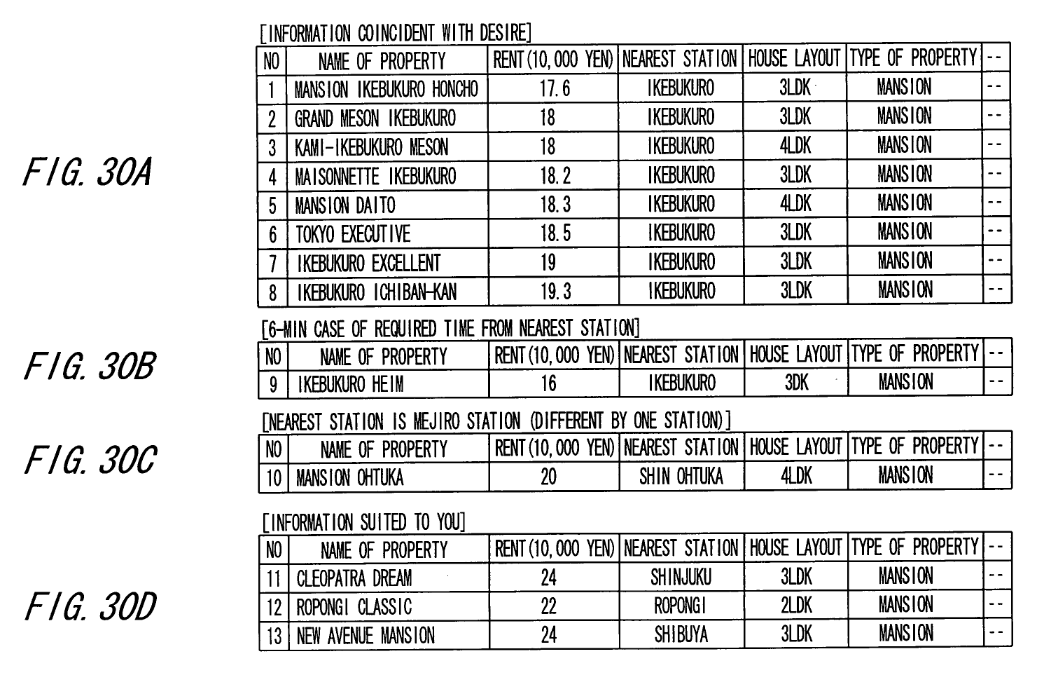

Next, the search result generation unit 110 creates the search results in a way that organizes the variation search results in a present-to-user format (FAX format) (S1411). Herein, FIG. 30 shows a conceptual diagram of the search results employed in the first embodiment of the information search device of the invention. FIG. 30A shows information coincident with a desire. FIG. 30B shows a case where it takes 6 minutes required from the nearest station. FIG. 30C shows a case where the nearest station is Mejiro Station (different from one station). FIG. 30D shows information suited to you.

(Output By FAX)

Next, the input/output unit 10 sends the search results of the user by FAX (S1412).

From the above-mentioned, in the first embodiment of the information search device of the invention, as shown in FIG. 10A, it is possible to prevent a large quantity of search results to be presented by setting the result maximum output count. Further, in the first embodiment of the information search device of the invention, the retrieved information is classified based on the point of view. Then, in the first embodiment of the information search device of the invention, the information is selected from among classified pieces of information and thus presented to the user. Therefore, a great variation of information can be presented to the user.

Moreover, in the first embodiment of the information search device of the invention, the implicit request conditions of the user are created, and the another-point-of-view information is extracted, whereby it is feasible to present the information held by the user as a implication desire.

### Second Embodiment

Next, a second embodiment of the information search device of the invention will be described. In the following discussion, different points from the aforementioned first embodiment of the information search device of the invention will be explained with reference to the drawings.

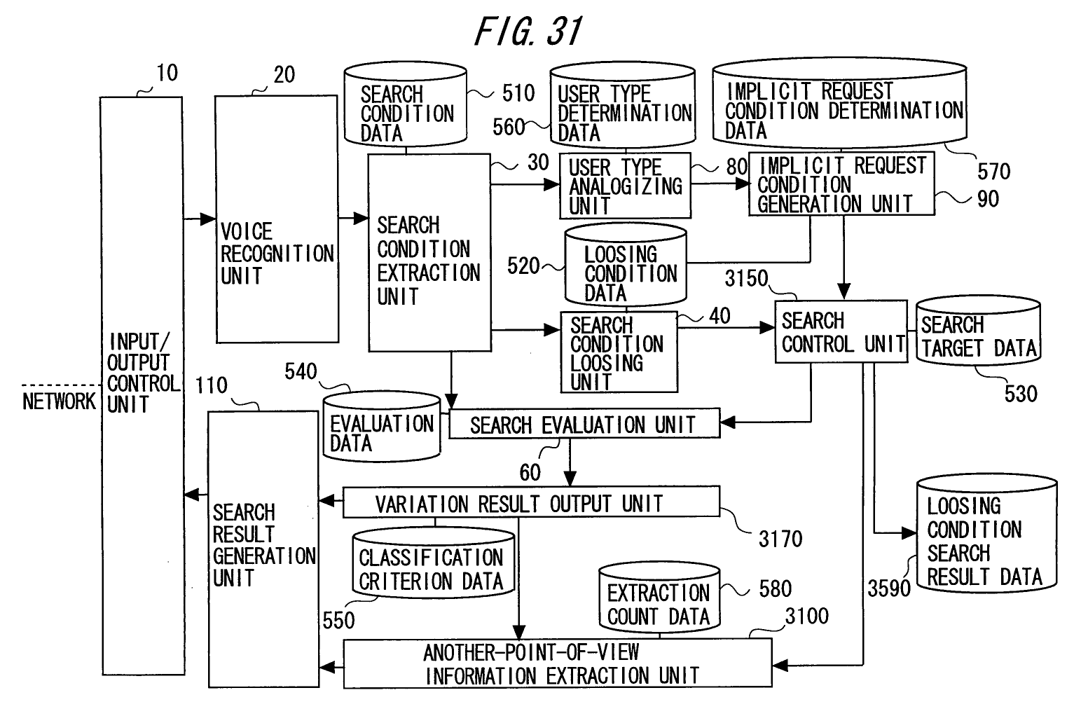

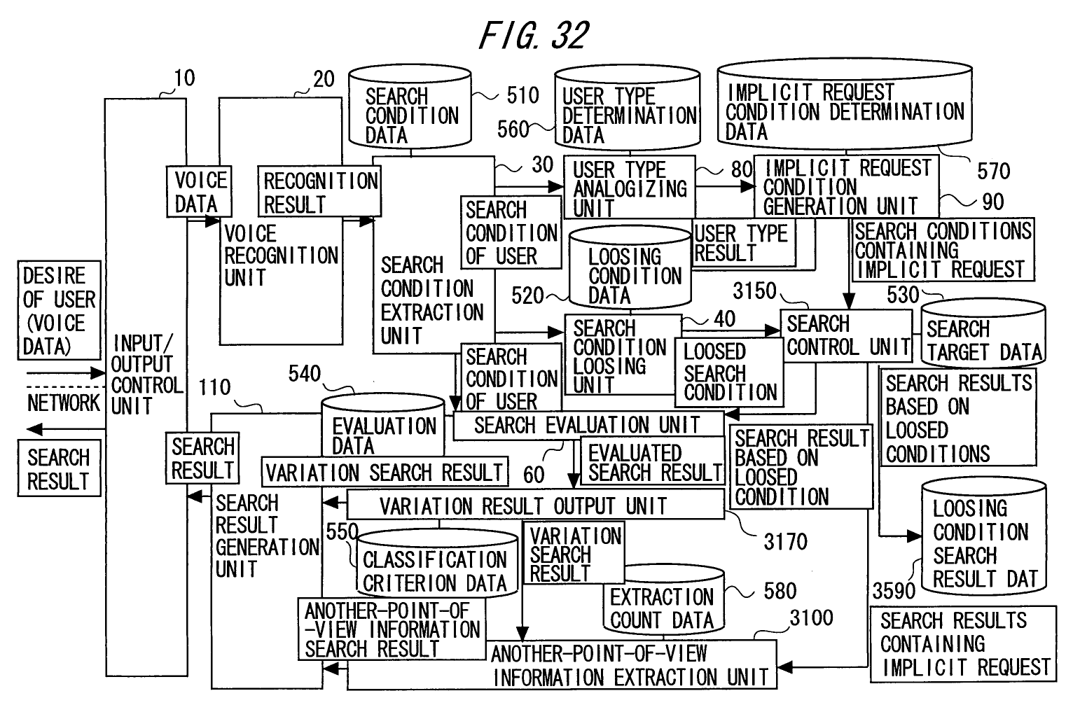

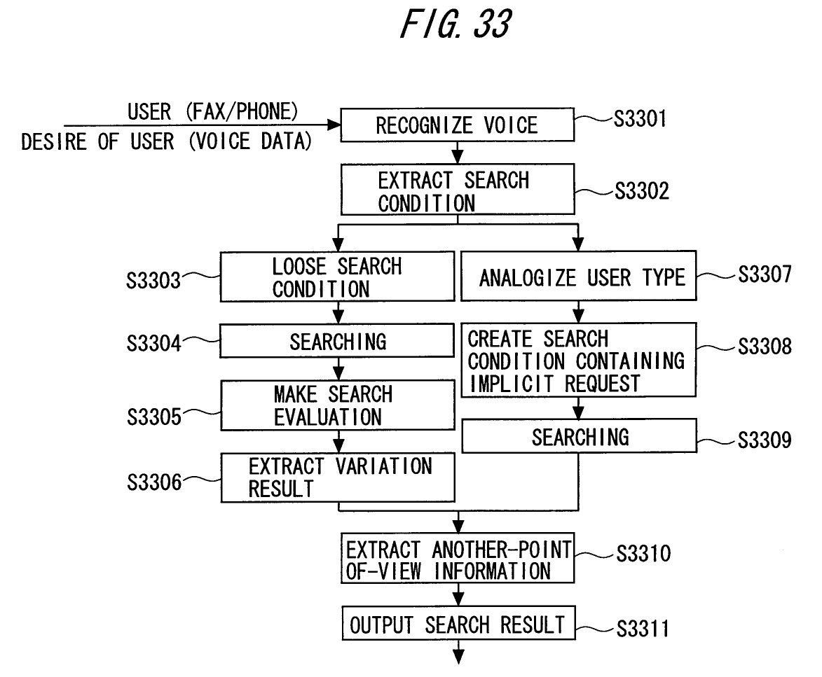

To begin with, an operation in the second embodiment will be described with reference to FIGS. 31, 32 and 33. FIGS. 31 and 32 are diagrams showing a principle of the second embodiment of the information search device of the invention. FIG. 33 of a flowchart showing the operation of the second embodiment of the information search device of the invention. An outline of the operation of the second embodiment is substantially the same as the operation of the first embodiment discussed above, and hence the description will be focused on the different portions.

(Voice Recognition)

To start with, an operation (S3301) of the voice recognition unit 20 shown in FIG. 31 is the same as in the first embodiment discussed above, and therefore its explanation is omitted.

(Extraction of Search Condition)

Further, an operation (S3302) of the search condition extraction unit 30 shown in FIG. 31 is the same as in the first embodiment discussed above, and hence its explanation is omitted.

(Looseation of Search Condition)

Moreover, an operation (S3303) of the search condition looseation unit 40 shown in FIG. 31 is the same as in the first embodiment discussed above, and therefore its explanation is omitted.

(Search)

A search control unit 3150 receives the loosed search conditions from the search condition loosing unit 40. Then, the search control unit 3150 extracts pieces of information coincident with conditions in the loosed search conditions from the search target data 530. Then, the search control unit 3150 creates search results based on loosed conditions (S3304).

Then, the search control unit 3150 transfers the search results based on the loosed conditions to the search evaluation unit 60. Subsequently, the search control unit 3150 stores the search results on loosing condition search result data 3590. The loosing condition search result data 3590 are data used for extracting the search results containing the implicit request of the user in the search control unit 3150.

(Search Evaluation)

An operation (S3305) of the search evaluation unit 60 is the same as the operation described in the first embodiment discussed above, and therefore its explanation is omitted.

(Extraction of Variation Result)

A variation result output unit 3170 receives the evaluated search results. Then, the variation result output unit 3170 classifies the evaluated search results based on the classification criterion data 550 for the purpose of not redundantly presenting similar pieces of information so that a broader range of information can be presented with brevity to the user.

The variation result output unit 3170 extracts the information so as not to extract the similar information from the thus-classified evaluated search results. Then, the variation result output unit 3170 creates the variation search results (S3306). Further, the variation result output unit 3170 transfers the thus-created variation search results to an another-point-of-view information extraction unit 3100 and to the search result generation unit 110.

(Analogizing of User Type)

An operation (S3307) of the user type analogizing unit 80 is the same as the operation in the first embodiment discussed above, and hence its explanation is omitted.

(Creation of Search Conditions Containing Implicit Request)

An operation (S3308) of the implicit request condition generation unit 90 is the same as the operation in the first embodiment discussed above, and hence its explanation is omitted.

(Search)

A search control unit 3150 receives the search conditions containing the implicit request. Then, the search control unit 3150 extracts, from the loosing condition search result data 3590, the information coincident with the conditions in the search conditions containing the implicit request. Subsequently, the search control unit 3150 creates the search results containing the implicit request. Then, the search control unit 3150 transfers the search results containing the implicit request to the another-point-of-view information extraction unit 3100 (S3309).

(Extraction of Another-Point-of-View Information)

The another-point-of-view information extraction unit 3100 receives the search results containing the implicit request. Then, the another-point-of-view information extraction unit 3100 extracts information that is not contained in the variation search results on the basis of the extraction count data 580 from the search results containing the implicit request and from the variation search results.

Subsequently, the another-point-of-view information extraction unit 3100 creates another-point-of-view information search results (S3310). Then, the another-point-of-view information extraction unit 3100 transfers the thus-created another-point-of-view information search results to the search result generation unit 110. Note that an operation (S3311) of the search result generation unit 110 is the same as the operation in the first embodiment discussed above, and hence its explanation is omitted.

Next, the operation of the second embodiment will be described in detail with reference to the drawings. As in the first embodiment discussed above, according to the second embodiment, the user accesses the voice information search service by phone. Then, according to the second embodiment, in a real estate rental property information search service system for obtaining pieces of rental property information, the user searches for the property information by setting conditions of three items such as the [rent], the [house layout] and the [nearest station]. Then, in the second embodiment, the user acquires a result by FAX. The second embodiment will exemplify such a case. The description will be, however, focused on different points from the first embodiment discussed above.

According to the second embodiment, the user gives a phone to the rental property information search service system. Thereupon, the rental property information search service system (which will hereinafter simply termed the system) answers such as [This is the 00 Service speaking. What type of property are you looking for?]. Then, the user speaks of conditions of a desired property like this: [Is there any property nearby Ikebukuro Station, rented at about 200,000 Yen and containing 3LDK?].

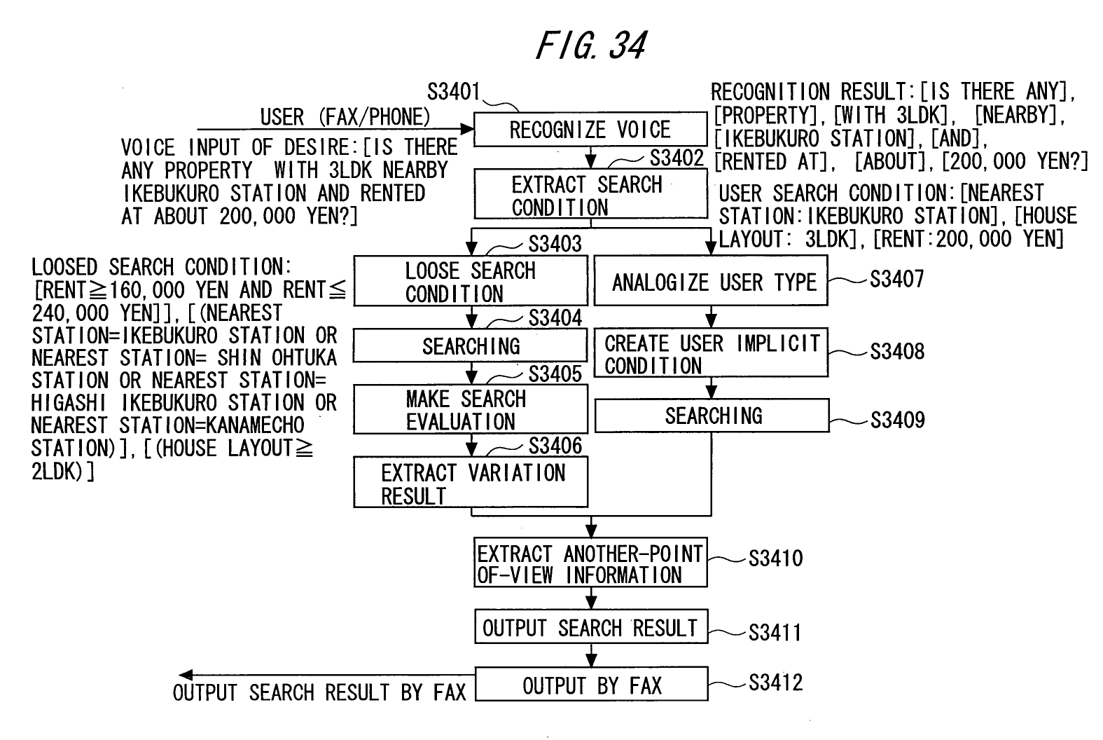

Next, a processing flow of the system in the second embodiment will be explained referring to FIGS. 34 and 32. FIG. 34 shows a flowchart of the operation in the second embodiment of the information search device of the invention. FIG. 32 is a diagram of a principle in the second embodiment of the information search device of the invention.

(Voice Recognition)

In the second embodiment, an operation (S3401) of the voice recognition unit 20 is the same as the operation described in the first embodiment discussed above, and hence its explanation is omitted.

(Extraction of Search Condition)

Further, in the second embodiment, an operation (S3402) of the search condition extraction unit 30 is the same as the operation described in the first embodiment discussed above, and hence its explanation is omitted.

(Loosing of Search Condition)

Moreover, in the second embodiment, an operation (S3403) of the search condition loosing unit 40 is the same as the operation described in the first embodiment discussed above, and hence its explanation is omitted.

(Search)

A search control unit 3150 receives the loosed conditions. Then, the search control unit 3150 generates [(the rent≧160,000 Yen and the rent≦240,000 Yen) and (the nearest station=Ikebukuro Station or the nearest station=Shin Ohtsuka Station or the nearest station=Higashi Ikebukuro Station or the nearest station=Kanamecho Station) and (the house layout≧2LDK)]. Subsequently, the search control unit 3150 searches for the property information from the search target data 530, and acquires search results based on the loosed conditions (S3404). Then, the search control unit 3150 transfers the search results based on the loosed conditions to the search evaluation unit 60, and stores the search results on the loosing condition search result data 3590. Herein, the search results based on the loosed conditions in the second embodiment are the same as those in FIG. 15 described in the first embodiment discussed above.

(Search Evaluation)

A search evaluating operation (S3405) of the search evaluation unit 60 in the second embodiment is the same as in the first embodiment discussed above, and therefore its explanation is omitted.

(Output of Variation Result)

A different point in operation of the variation result output unit 3170 in the second embodiment from the operation of the variation result output unit 70 in the first embodiment is an output destination of the variation search results. To be specific, the variation result output unit 3170 extracts variation search results shown in FIG. 24 as a combination of the properties acquired from the point-of-view classified results and the properties acquired from the divergence degree classified results (S3406). Then, the variation result output unit 3170 transfers the extracted information to the another-point-of-view information extraction unit 3100 and to the search result generation unit 110.

(Analogizing of User Type)

In the second embodiment, an operation (S3407) of the user type analogizing unit 80 is the same as in the first embodiment discussed above, and hence its explanation is omitted.

(Creation of User Implicit Request Condition)

In the second embodiment, an operation (S3408) of creating the search conditions containing the implicit request by the implicit request condition generation unit 90, is the same as the operation in the first embodiment, and therefore its explanation is omitted.

(Search)

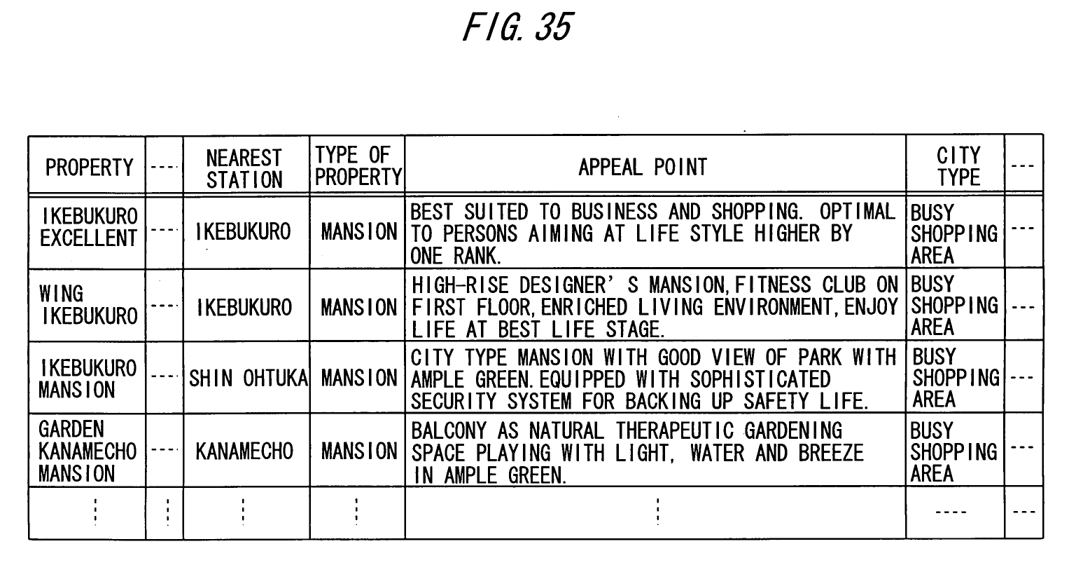

The search control unit 3150 receives the search conditions containing the implicit request. Then, the search control unit 3150 extracts from the loosing condition search result data 3590 a piece of information that meets the condition in the search conditions containing the implicit request. Subsequently, the search control unit 3150 creates the search results containing the implicit request (S3409). Then, the search control unit 3150 transfers the search results containing the implicit request to the another-point-of-view information extraction unit 3100. Herein, FIG. 35 shows a conceptual diagram of the search results containing the implicit request used in the second embodiment of the information search device of the invention.

(Extraction of Another-Point-of-View Information)

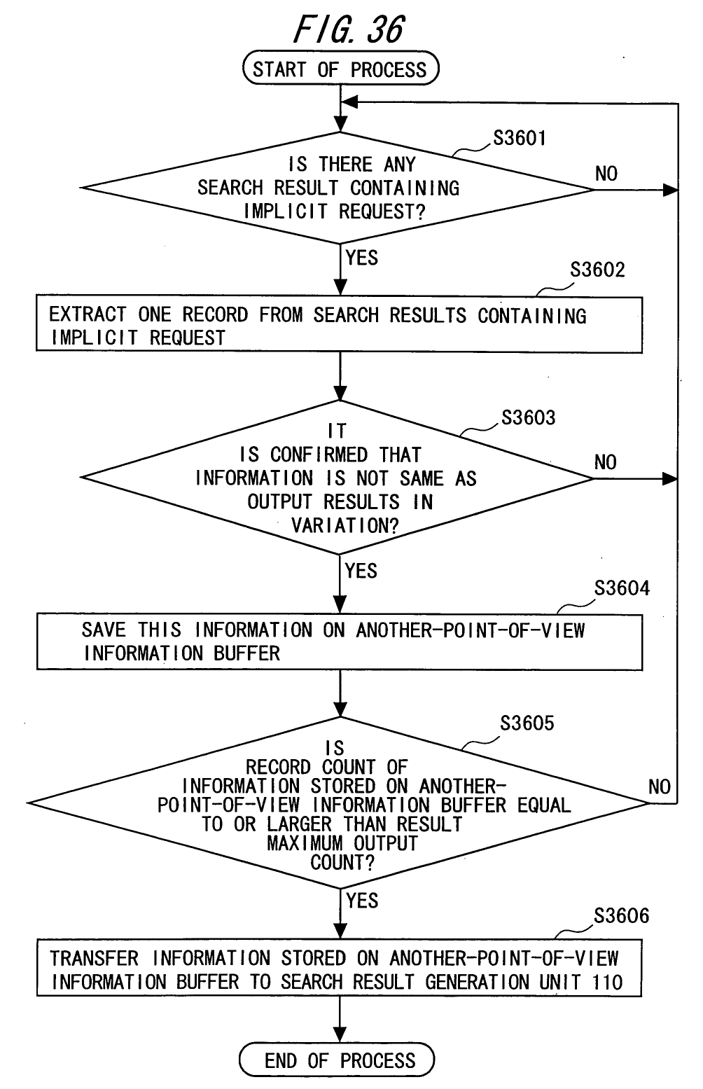

The another-point-of-view information extraction unit 3100 receives the search results containing the implicit request. Then, the another-point-of-view information extraction unit 3100 extracts information in accordance with a flowchart of the another-point-of-view information extraction unit in FIG. 36 by use of the extraction count data 580 from the search results containing the implicit request on the basis of the variation search results (S3410). FIG. 36 is the flowchart of an operation of the another-point-of-view information extraction unit in the second embodiment of the information search device of the invention.

Namely, the another-point-of-view information extraction unit 3100 judges whether or not there is the search result containing the implicit request (S3601). The another-point-of-view information extraction unit 3100 advances to S3602 when there is the search result containing the implicit request and moves to S3606 when there is not the search result containing the implicit request.

Next, the another-point-of-view information extraction unit 3100 extracts one record from the search results containing the implicit request (S3602). Subsequently, the another-point-of-view information extraction unit 3100 checks whether or not the information is the same as the variation output result (S3603). Then, the another-point-of-view information extraction unit 3100 advances to S3604 if not the same as the variation output result and moves back to S3601 if the information is the same as the variation output result.

The another-point-of-view information extraction unit 3100 stores the information on the another-point-of-view information buffer (S3604). Subsequently, the another-point-of-view information extraction unit 3100 judges whether or not a record count of the information stored on the another-point-of-view information buffer is a result maximum output count (S3605). Then, the another-point-of-view information extraction unit 3100 advances to S3606 when the record count of the information stored on the another-point-of-view information buffer is the result maximum output count, but moves back to S3601 when the record count of the information stored on the another-point-of-view information buffer is not the result maximum output count.

Next, the another-point-of-view information extraction unit 3100 transfers the information stored on the another-point-of-view information buffer to the search result generation unit 110. Thereafter, the another-point-of-view information extraction unit 3100 finishes the operation. Through the processes described above, the another-point-of-view information extraction unit 3100 creates the another-point-of-view information search results.

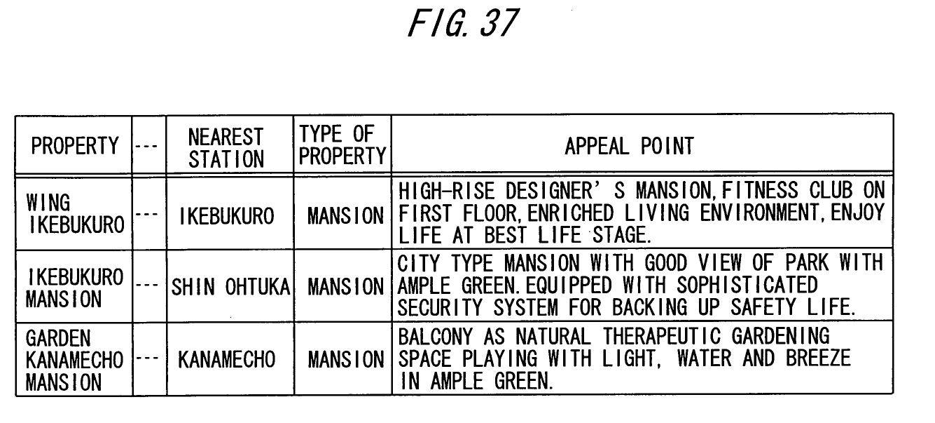

Then, the another-point-of-view information extraction unit 3100 transfers the thus-created another-point-of-view information search results to the search result generation unit 110. FIG. 37 shows a conceptual diagram of the another-point-of-view information search results in the second embodiment of the information search device of the invention. In an example shown in FIG. 37, “Ikebukuro Excellent” is contained in the variation search results and is therefore excluded.

(Output of Search Result)

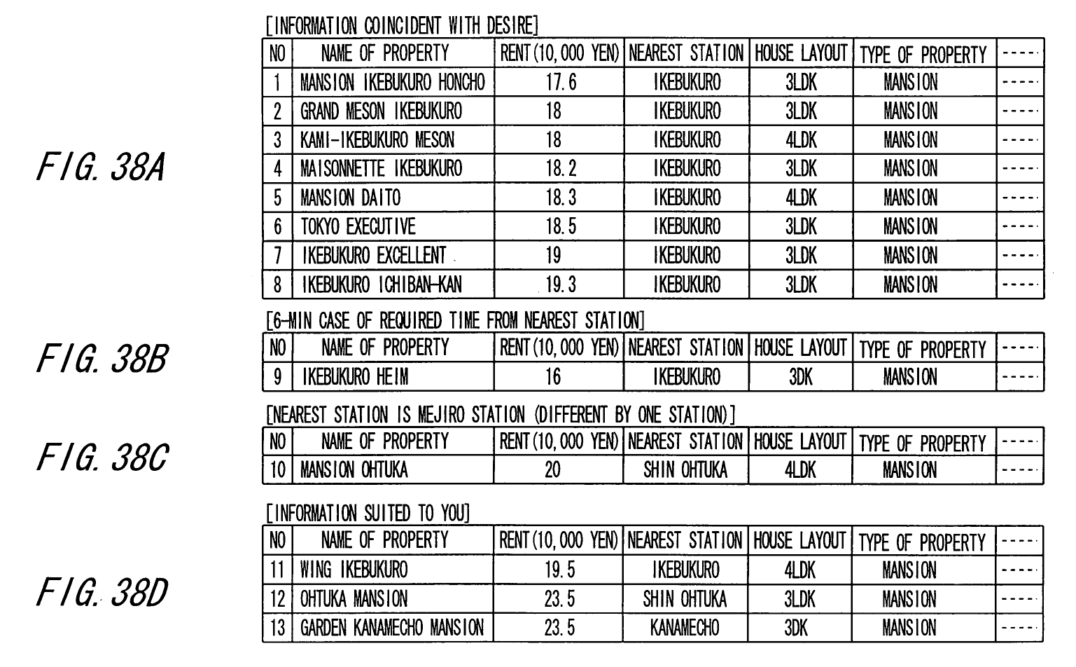

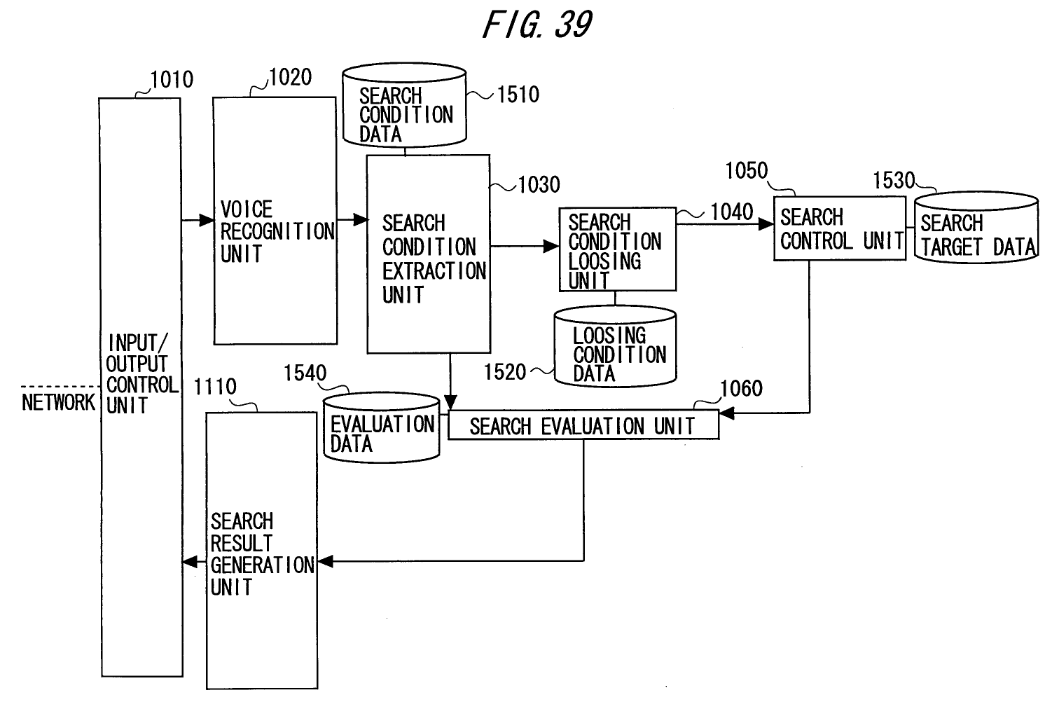

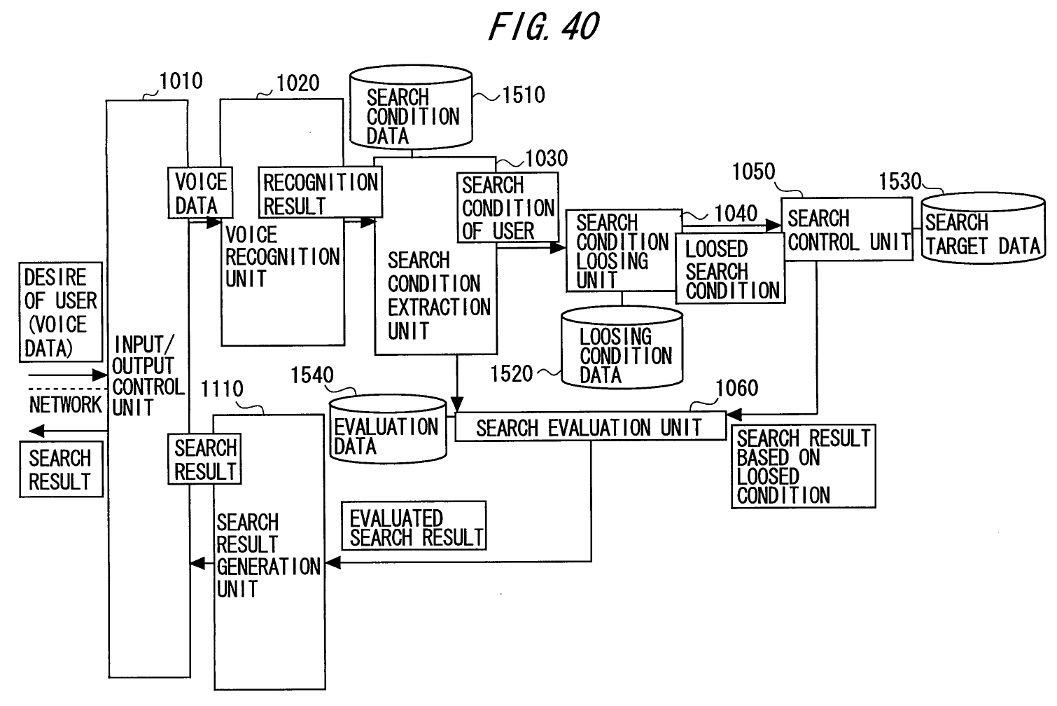

The search result generation unit 110 creates the search results in a way that organizes the variation search results in a present-to-user format (FAX format) (S3411). Herein, FIG. 38A, FIG. 38B, FIG. 38C and FIG. 38D shows a conceptual diagram of the search results in the second embodiment of the information search device of the invention. Note that a FAX output process (S3412) of the input/output control unit 10 in the second embodiment is the same as the FAX output process of the input/output control unit 10 explained in the first embodiment discussed above, and hence its explanation is omitted.

As described above, according to the second embodiment of the information search device of the invention, the search control unit 3150 performs searching from the loosing condition search result data 3590 by use of the search conditions containing the implicit request. It is therefore possible to acquire the search result coincident with the implicit request in the second embodiment from among the loosed search results.

Further, according to the second embodiment of the information search device of the invention, the another-point-of-view information extraction unit 3100 outputs a predetermined or less number of search results as the another-point-of-view information search results from among the search results containing the implicit request, which are not contained in the variation search results. Therefore, according to the second embodiment, the information with brevity can be presented to the user.

Thus, according to the invention, the variation result output unit classifies the search results added with the divergence degrees by use of classification criterion data for classifying the search results on the basis of the divergence degrees, selects the search result from among the classified search results and thus outputs the search result. Therefore, it is possible to eliminate redundancy of the search results exhibiting a plurality of close categories of attributes and to simplify the search results to be presented to the user. Moreover, according to the invention, the search result is selected from among the classified search results, and hence the search result exhibiting a high variation can be presented to the user.

Further, according to the invention, the user type analogizing unit determines a type of the user from the search conditions of the user by use of user type determination data for determining the type of the user, and outputs a user type result. The implicit request condition generation unit creates the search conditions containing a implicit request from the user type result by use of implicit request condition determination data for determining conditions implicitly requested by the user. The search control unit performs a search based on the search conditions containing the implicit request, and outputs the search results. It is therefore feasible to output the search results based on the implicit request of the user.

As described above, according to the invention, it is possible to present the search results with brevity and with a high variation in such a form that respective pieces of information of the search results have different features with respect to the search conditions inputted by the user. Furthermore, according to the invention, it is feasible to present by adding the information that meets the request implicitly held by the user. Therefore, the invention can obtain the following effects.

[Effect Yielded by Presenting High-Variation Search Results with Brevity]

The information presented to the user according to the invention contains the information that meets the implicit request of the user in the search results with brevity, and is a set of the search results exhibiting the high variation. Hence, the invention shows by far a more improved probability of presenting the information satisfactory to the user. Then, the invention enables the user to save a labor of browsing the search results to the greatest possible degree. Then, the invention enables the information desired by the user to be searched out speedily. Moreover, the invention facilitates the acquirement of the search results through Voice portal, PDA, i-mode (registered trademark), etc. by which the user is hard to acquire a mass of information.

[Effect Yielded by Presenting Data Meeting Implication Desire]

According to the invention, the implicit request conditions of the user are created. Then, in the invention, the information is searched for by use of the implicit request conditions. Therefore, according to the invention, it is feasible to obtain the data meeting the implication desire of the user by one-shot search. Hence, the invention shows an improvement of a search efficiency. For instance, in the case of offering a real estate property, there is a high possibility in which the user is to select an property showing a higher degree of satisfaction even when this property is priced slightly higher than an originally-set desired amount of money, so that the invention contributes to improve a rate of establishing a contract of a high-priced property.

According to the invention, the following effects are further obtained as subsidiary effects.

[Subsidiary Effects]

According to the invention, the information meeting the implicit request of the user can be presented with brevity to the user. Therefore, the degree of satisfaction of the user is improved. Consequently, the invention makes it feasible to increase an access count of the user to the service including the invention. It is therefore possible to provide the service exhibiting a high reuse rate and a high continuous use rate of the user. Hence, the service utilizing the invention gains an increased income from advertisement.

Further, according to the invention, the variations from multiple points of view are presented as the search results. Hence, in the invention, the information to be presented to the user can be offered from a broad range of viewpoint.

Consequently, according to the invention, a probability that a system installer might miss a business chance, is reduced.

1. An information search device comprising:
a search condition extraction unit extracting search conditions of a user from inputted information;
a search condition loosing unit loosing the search conditions of the user and thus creating loosed search conditions;
a search control unit performing a search based on the loosed search conditions and outputting search results;
a search evaluation unit adding divergence degrees to the search results by use of the search conditions of the user and evaluation data for evaluating the search results, and thus outputting the search results; and
a variation result output unit classifying the search results added with the divergence degrees by use of classification criterion data for classifying the search results on the basis of the divergence degrees, selecting the search result from among the classified search results and thus outputting the search result.

2. An information search device according to claim 1, wherein the search condition contains at least one or more tuples of attributes possessed by a search target and information indicating the attributes,
the loosed search condition contains at least one or more tuples of the attributes and information into which the information indicating the attributes is changed,
the evaluation data contain information for determining the divergence degrees based on the information indicating attributes of the search results searched based on the loosed search conditions and information indicating attributes contained in the search conditions of the user, and
said search evaluation unit adds the divergence degrees to the search results based on the information for determining the divergence degrees, and thus outputs the search results.

3. An information search device comprising:
a search condition extraction unit extracting search conditions of a user from inputted information;
an user type analogizing unit determining a type of the user from the search conditions of the user by use of user type determination data for determining the type of the user from inputted information, and outputting a user type result;
a implicit request condition generation unit creating the search conditions containing a implicit request from the user type result by use of implicit request condition determination data for determining conditions implicitly requested by the user; and
a search control unit performing a search based on the search conditions containing the implicit request, and outputting a search results.

4. An information search device according to claim 3, wherein the search condition contains at least one or more tuples of attributes possessed by a search target and information indicating the attributes,
the user type is set in the user type determination data in a way that associates the user type with the information indicating the attributes,
said user type analogizing unit outputs the user type in the user type determination data, associated with the information indicating the attribute contained in the search conditions of the user, and
the implicit request condition is set in the implicit request condition determination data in a way that associates the implicit request condition with the user type result.

5. An information search device according to claim 3, further comprising an another-point-of-view information extraction unit extracting the search results of which a result count is indicated by extraction count data indicating an extraction count from the search results outputted from said search control unit.

6. An information search device comprising:
search condition extraction unit extracting search conditions of a user from inputted information;
a search condition loosing unit loosing the search conditions of the user and thus creating loosed search conditions;
a search control unit performing a search based on the loosed search conditions and outputting first search results;
a search evaluation unit adding divergence degrees to the first search results by use of the search conditions of the user and evaluation data for evaluating the search results, and thus outputting the first search results;
a variation result output unit classifying the first search results added with the divergence degrees by use of classification criterion data for classifying the search results on the basis of the divergence degrees, selecting second search results from among the classified first search results and thus outputting the second search results;
an user type analogizing unit determining a type of the user from the search conditions of the user by use of user type determination data for determining the type of the user, and outputting a user type result; and
a implicit request condition generation unit creating the search conditions containing a implicit request from the user type result by use of implicit request condition determination data for determining conditions implicitly requested by the user,
wherein said search control unit searches the first search results on the basis of the search conditions containing the implicit request, and outputs the search results containing the implicit request, and
said information search device comprises an another-point-of-view information extraction unit extracting information, which is not contained in the second search results, from the search results containing the implicit request.

7. An information search device according to claim 6, wherein the search condition contains at least one or more tuples of attributes possessed by a search target and information indicating the attributes,
the loosed search condition contains at least one or more tuples of the attributes and information into which the information indicating the attributes is changed,
information for determining the divergence degrees based on the information indicating attributes of the first search results and information indicating attributes contained in the search conditions of the user, is set in the evaluation data,
said search evaluation unit adds the divergence degrees to the first search results based on the information for determining the divergence degrees, and thus outputs the first search results,
the user type is set in the user type determination data in a way that associates the user type with the information indicating the attributes,
said user type analogizing unit outputs the user type in the user type determination data, associated with the information indicating the attribute contained in the search conditions of the user, and
the implicit request condition is set in the implicit request condition determination data in a way that associates the implicit request condition with the user type result.

8. An information search device according to claim 6, wherein said another-point-of-view information extraction unit extracts the search results of which a result count is indicated by extraction count data indicating an extraction count from the search results containing the implicit request that are outputted from said search control unit.

9. A computer program for searching information comprising steps of:
extracting search conditions of a user from inputted information;
loosing the search conditions of the user;
creating loosed search conditions;
performing a search based on the loosed search conditions;
outputting search results;
adding divergence degrees to the search results by use of the search conditions of the user and evaluation data for evaluating the search results;
outputting the search results added with the divergence degrees;
classifying the search results added with the divergence degrees by use of classification criterion data for classifying the search results on the basis of the divergence degrees;
selecting the search result from among the classified search results; and
outputting the selected search result.

10. A computer program according to claim 9, wherein the search condition contains at least one or more tuples of attributes possessed by a search target and information indicating the attributes,
the loosed search condition contains at least one or more tuples of the attributes and information into which the information indicating the attributes is changed,
the evaluation data contain information for determining the divergence degrees based on the information indicating attributes of the search results searched based on the loosed search conditions and information indicating attributes contained in the search conditions of the user, and
the computer program comprises a step of adding the divergence degrees to the search results based on the information for determining the divergence degrees, and thus outputting the search results.

11. A computer program for searching information comprising steps of:
extracting search conditions of a user from inputted information;
determining a type of the user from the search conditions of the user by use of user type determination data for determining the type of the user from inputted information;
outputting a user type result;
creating the search conditions containing a implicit request from the user type result by use of implicit request condition determination data for determining conditions implicitly requested by the user;
performing a search based on the search conditions containing the implicit request; and
outputting a search results.

12. A computer program according to claim 11, wherein the search condition contains at least one or more tuples of attributes possessed by a search target and information indicating the attributes,
the user type is set in the user type determination data in a way that associates the user type with the information indicating the attributes,
the computer program comprises a step of outputting the user type in the user type determination data, associated with the information indicating the attribute contained in the search conditions of the user, and
the implicit request condition is set in the implicit request condition determination data in a way that associates the implicit request condition with the user type result.

13. A computer program according to claim 11, further comprising a step of extracting the search results of which a result count is indicated by extraction count data indicating an extraction count from the search results outputted from the outputting step.

14. A computer program for searching information comprising steps of:
extracting search conditions of a user from inputted information;
loosing the search conditions of the user;
creating loosed search conditions;
performing a search based on the loosed search conditions;
outputting first search results;
adding divergence degrees to the first search results by use of the search conditions of the user and evaluation data for evaluating the search results;
outputting the first search results added with the divergence degrees;
classifying the first search results added with the divergence degrees by use of classification criterion data for classifying the search results on the basis of the divergence degrees;
selecting second search results from among the classified first search results;
outputting the second search results;
determining a type of the user from the search conditions of the user by use of user type determination data for determining the type of the user;
outputting a user type result;
creating the search conditions containing a implicit request from the user type result by use of implicit request condition determination data for determining conditions implicitly requested by the user;
searching the first search results on the basis of the search conditions containing the implicit request;
outputting the search results containing the implicit request; and
extracting information, which is not contained in the second search results, from the search results containing the implicit request.

15. A computer program according to claim 14, wherein the search condition contains at least one or more tuples of attributes possessed by a search target and information indicating the attributes,
the loosed search condition contains at least one or more tuples of the attributes and information into which the information indicating the attributes is changed,
information for determining the divergence degrees based on the information indicating attributes of the first search results and information indicating attributes contained in the search conditions of the user, is set in the evaluation data,
the computer program comprises a step of adding the divergence degrees to the first search results based on the information for determining the divergence degrees, and thus outputting the first search results,
the user type is set in the user type determination data in a way that associates the user type with the information indicating the attributes,
the computer program comprises a step of outputting the user type in the user type determination data, associated with the information indicating the attribute contained in the search conditions of the user, and
the implicit request condition is set in the implicit request condition determination data in a way that associates the implicit request condition with the user type result.

16. A computer program according to claim 14, further comprising a step of extracting the search results of which a result count is indicated by extraction count data indicating an extraction count from the search results containing the implicit request that are outputted from the outputting step.

17. An information search method comprising steps of:
extracting search conditions of a user from inputted information;
loosing the search conditions of the user;
creating loosed search conditions;
performing a search based on the loosed search conditions;
outputting search results;
adding divergence degrees to the search results by use of the search conditions of the user and evaluation data for evaluating the search results;
outputting the search results added with the divergence degrees; and
classifying the search results added with the divergence degrees by use of classification criterion data for classifying the search results on the basis of the divergence degrees;
selecting the search result from among the classified search results; and
outputting the search result.

18. An information search method according to claim 17, wherein the search condition contains at least one or more tuples of attributes possessed by a search target and information indicating the attributes,
the loosed search condition contains at least one or more tuples of the attributes and information into which the information indicating the attributes is changed,
the evaluation data contain information for determining the divergence degrees based on the information indicating attributes of the search results searched based on the loosed search conditions and information indicating attributes contained in the search conditions of the user, and
the method comprises a step of adding the divergence degrees to the search results based on the information for determining the divergence degrees, and thus outputting the search results.

19. An information search method comprising steps of:
extracting search conditions of a user from inputted information;
determining a type of the user from the search conditions of the user by use of user type determination data for determining the type of the user from inputted information;
outputting a user type result;
creating the search conditions containing a implicit request from the user type result by use of implicit request condition determination data for determining conditions implicitly requested by the user;
performing a search based on the search conditions containing the implicit request; and
outputting a search results.

20. An information search method according to claim 19, wherein the search condition contains at least one or more tuples of attributes possessed by a search target and information indicating the attributes,
the user type is set in the user type determination data in a way that associates the user type with the information indicating the attributes,
the method comprises a step of outputting the user type in the user type determination data, associated with the information indicating the attribute contained in the search conditions of the user, and
the implicit request condition is set in the implicit request condition determination data in a way that associates the implicit request condition with the user type result.

21. An information search method according to claim 19, further comprising a step of extracting the search results of which a result count is indicated by extraction count data indicating an extraction count from the search results outputted from the outputting step.

22. An information search method comprising steps of:
extracting search conditions of a user from inputted information;
loosing the search conditions of the user;
creating loosed search conditions;
performing a search based on the loosed search conditions;
outputting first search results;
adding divergence degrees to the first search results by use of the search conditions of the user and evaluation data for evaluating the search results;
outputting the first search results added with the divergence degrees;
classifying the first search results added with the divergence degrees by use of classification criterion data for classifying the search results on the basis of the divergence degrees;
selecting second search results from among the classified first search results;
outputting the second search results;
determining a type of the user from the search conditions of the user by use of user type determination data for determining the type of the user;
outputting a user type result;
creating the search conditions containing a implicit request from the user type result by use of implicit request condition determination data for determining conditions implicitly requested by the user;
searching the first search results on the basis of the search conditions containing the implicit request;
outputting the search results containing the implicit request; and
extracting information, which is not contained in the second search results, from the search results containing the implicit request.

23. An information search method according to claim 22, wherein the search condition contains at least one or more tuples of attributes possessed by a search target and information indicating the attributes,
the loosed search condition contains at least one or more tuples of the attributes and information into which the information indicating the attributes is changed,
information for determining the divergence degrees based on the information indicating attributes of the first search results and information indicating attributes contained in the search conditions of the user, is set in the evaluation data,
the method comprises a step of adding the divergence degrees to the first search results based on the information for determining the divergence degrees, and thus outputting the first search results,
the user type is set in the user type determination data in a way that associates the user type with the information indicating the attributes,
the method comprises a step of outputting the user type in the user type determination data, associated with the information indicating the attribute contained in the search conditions of the user, and
the implicit request condition is set in the implicit request condition determination data in a way that associates the implicit request condition with the user type result.

24. An information search method according to claim 22, further comprising a step of extracting the search results of which a result count is indicated by extraction count data indicating an extraction count from the search results containing the implicit request that are outputted from the outputting step.
